(19) United States
(12) Patent Application Publication
(10) Pub. No.: US 2022/0284516 A1
(43) Pub. Date: Sep. 8, 2022

(54) INSURANCE RISK MANAGEMENT SYSTEMS AND METHODS

(71) Applicant: BERKELEY POINT CAPITAL LLC, BETHESDA, MD (US)

(72) Inventors: Deborah Lucia, Medford, MA (US); Jeffrey Giudici, Westwood, MA (US); Damon Khouri, Hanover, MA (US); Hoang Hguyen, Revere, MA (US); Michael Schroeder, Westwood, MA (US); Stacia Telsey, Glen Allen, VA (US)

(21) Appl. No.: 17/751,903

(22) Filed: May 24, 2022

Related U.S. Application Data
(63) Continuation of application No. 16/802,530, filed on Feb. 26, 2020.
Application No. 16/802,530 is a continuation of application No. 14/745,375, filed on Jun. 19, 2015, now abandoned.
(60) Provisional application No. 62/014,493, filed on Jun. 19, 2014.

(51) Int. Cl. G06Q 40/08

(52) U.S. Cl. CPC G06Q 40/08

(57) ABSTRACT

Various embodiments are directed to systems and methods for tracking and managing compliance for a plurality of insurance policies on a plurality of properties or other collateral. Insurance, loan, and compliance information may be received and stored in a database. The database may be updated periodically based on new loan, insurance, and compliance information. Users may manage and track the changing compliance status of each loan and policy. Alerts may input, stored, and/or auto generated to flag compliance issues. Communications such as compliance letters may be automatically generated according to a predetermined schedule based on compliance status. Supporting documents associated with compliance requirements may be stored and displayed to users to facilitate compliance tracking and management.

### RELATED APPLICATIONS

This application is a continuation of U.S. patent application Ser. No. 16/802,530 filed Feb. 26, 2020, which is a continuation of U.S. patent application Ser. No. 14/745,375 filed on Jun. 19, 2015, which claims the benefit of U.S. Provisional Application Ser. No. 62/014,493, filed Jun. 19, 2014, the disclosures of which are incorporated by reference herein in their entireties.

### FIELD OF THE INVENTION

The present invention generally relates to electronic systems and methods for managing risk, such as insurance risk.

### BACKGROUND

Various companies and third-party providers ensure that companies that collateralize loans have proper insurance, e.g., to ensure that the owner of the loan(s) is protected, e.g., in the event of a natural disaster. Several companies who provide such insurance use Enterprise software, such as that provided by Midland.

### BRIEF SUMMARY OF THE INVENTION

Various embodiments of the present invention relate to an electronic data management system that tracks and displays, for a plurality of different loans or other financial instruments, information related to the loans, such as information about the status of the loan or other financial instrument (e.g., whether a particular loan is in effect), availability and status of documentation related to the loan, payment information, and other information. The system can generate communications such as auto-generated letters for communicating information (such as action items, status reports, deficiency notices, etc.) to various relevant parties such as a borrower, lender, insurance provider, mortgage holder or servicer, title holder, title company, bank, or other entity.

### BRIEF DESCRIPTION OF THE FIGURES

To provide a more complete understanding of the present invention and features and advantages thereof, reference is made to the following description, taken in conjunction with the accompanying figures, wherein like reference numerals represent like parts, in which:

FIG. 1 depicts an exemplary apparatus according to an embodiment.

FIG. 2 depicts an exemplary database configuration according to an embodiment.

FIG. 3 depicts an exemplary business layer of an application according to an embodiment.

FIG. 4 depicts an exemplary data layer of an application according to an embodiment.

FIG. 5 depicts an exemplary database structure according to an embodiment.

FIG. 6 depicts exemplary nightly process functionality according to an embodiment.

FIG. 7 depicts exemplary loan property exceptions according to various embodiments.

FIG. 8 depicts an exemplary method according to an embodiment.

FIG. 9 depicts an exemplary method according to an embodiment.

FIGS. 10-54 depict exemplary user interfaces and functionalities according to various embodiments.

FIGS. 10-21 depict exemplary user interfaces and functionalities of a search tab according to an embodiment.

FIG. 22 depicts an exemplary user interface and functionality of a dashboard tab according to an embodiment.

FIGS. 23-26 depict exemplary user interfaces and functionalities of a “to be reviewed” tab according to an embodiment.

FIGS. 27-32 depict exemplary user interfaces and functionalities of a compliance queue tab according to an embodiment.

FIGS. 33-38 depict exemplary user interfaces and functionalities of a reminders tab according to an embodiment.

FIGS. 39-44 depict exemplary user interfaces and functionalities of a policy detail tab according to an embodiment.

FIGS. 45-54 depict exemplary user interfaces and functionalities of, or accessible via, a policy checklist tab according to an embodiment.

### DETAILED DESCRIPTION OF EXEMPLARY EMBODIMENTS

Many insurers and loan companies deal with hundreds, thousands, or hundreds of thousands of loans. Conventional enterprise software providers do not track certain relevant information for each of the many loans in a given portfolio (which can number in the hundreds, thousands, and hundreds of thousands), such as whether or not hundreds of thousands of loans are in effect or not in effect, and whether all the necessary documents (such as supporting documents) for each loan are valid, up to date, or extant.

According to various embodiments of the present invention, an electronic data management system may track, manage, and display (e.g., to users), information related to a plurality of different loans. The information may include information about the status of the loan (e.g., whether a particular loan is in effect), availability and status of documentation related to the loan, payment information concerning the loan (e.g., information about payments made on the loan), and other information.

Various embodiments are directed to systems and methods for tracking and managing compliance for a plurality of insurance policies on a plurality of properties or other collateral. Insurance, loan, and compliance information may be received and stored in a database. The database may be updated periodically based on new loan, insurance, and compliance information. Users may manage and track the changing compliance status of each loan and policy. Alerts may input, stored, and/or auto generated to flag compliance issues. Communications such as compliance letters may be automatically generated according to a predetermined schedule based on compliance status. Supporting documents associated with compliance requirements may be stored and displayed to users to facilitate compliance tracking and management.

In some embodiments, systems, apparatus, methods, and computer-readable media are provided for tracking and managing information about one or more insurance policies, loans, compliance issues, requirements, and/or other information. In some embodiments, for each of a plurality of properties that each comprise collateral for one or more loans each having insurance requirements, at least one processor may receive insurance information concerning each of one or more insurance policies associated with the respective property. The insurance information may comprise compliance information indicative of whether one or more predetermined insurance requirements applicable to the respective one or more insurance policies associated with the respective property have been satisfied. The one or more predetermined insurance requirements may comprise a first requirement applicable to a first insurance policy and a second requirement applicable to a second insurance policy. The processor may be in electronic communication with at least one memory having at least one database.

In some embodiments, based on the received compliance information, the at least one processor may determine, for each of the one or more loans on each of the plurality of properties, whether each of the respective one or more predetermined insurance requirements have been satisfied. The act of determining whether each of the respective one or more predetermined insurance requirements have been satisfied may comprise (1) determining that the first requirement associated with the first insurance policy has been satisfied and (2) determining that the second requirement associated with the second policy has not been satisfied.

In some embodiments, the at least one processor may populate the at least one database based on the received insurance information. The act of populating the at least one database may comprise (1) storing, in a first database entry associated with the first insurance policy, information indicating that the first requirement has been satisfied and (2) storing, in a second database entry associated with the second insurance policy, information indicating that the second requirement has not been satisfied.

In some embodiments, the at least one processor may receive from a first user a first request for information about whether the first requirement has been satisfied. Responsive to the first request, the at least one processor may query the first database entry. Responsive to querying the first database entry, the at least one processor may cause first indicia indicating that the first requirement has been satisfied to be displayed at a user interface.

In some embodiments, the at least one processor may receive a second request for information about whether the second requirement has been satisfied. Responsive to the second request, the at least one processor may query the second database entry. Responsive to querying the second database entry, the at least one processor may cause second indicia indicating that the second requirement has not been satisfied to be displayed at a user interface.

In some embodiments, after causing the second indicia to be displayed, the at least one processor may receive updated compliance information. The at least one processor may determine that the second requirement has been satisfied based on the updated compliance information.

In some embodiments, the at least one processor may receive a third request for information about whether the second requirement has been satisfied. Responsive to the third request, the at least one processor may cause third indicia indicating that the second requirement has been satisfied to be displayed at a user interface.

In some embodiments, a user software application 10 may download information from central server 2. In some embodiments, the software application may be interoperable with, or may have APIs and other features similar to, those of the Enterprise software from Midland. In some embodiments, a central server 2 may receive information from a data source, e.g., periodically (e.g., once or more every day or week, such as nightly). Users 10 may log into a portal to input and edit data concerning one or more loans. In some embodiments, a user interface may display to users 10 (e.g., to a manager) a dashboard showing information about a loan or plurality of loans and may provide information about risk associated with one or more loans.

### Exemplary System

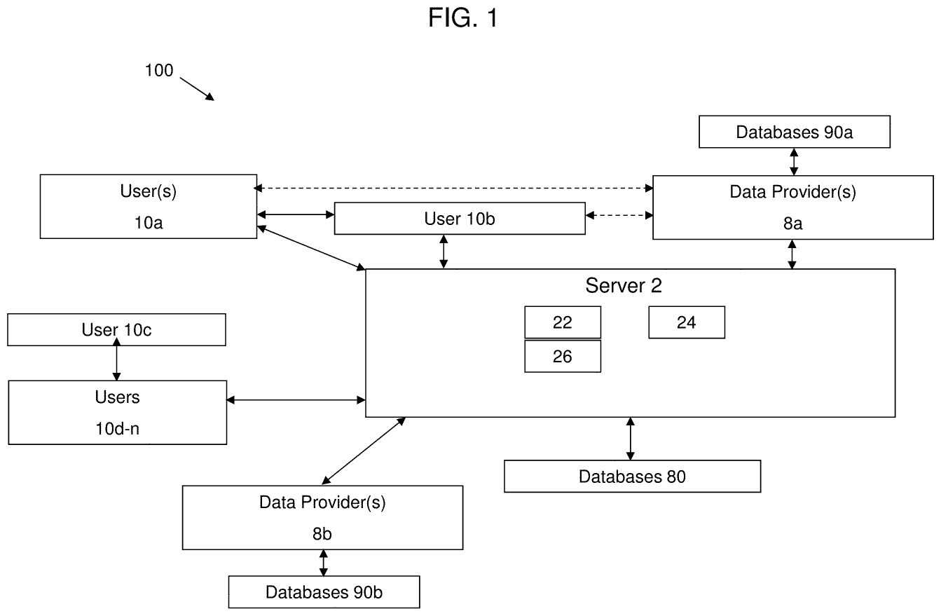

FIG. 1 depicts an exemplary apparatus according to an embodiment.

The system 100 may comprise one or more servers 2 coupled to one or more databases 80, one or more data providers 8a-8n, and one or more end users 10a-10n. The data providers 8a-8n, users 10, and server 2 may each communicate with each other. Users 10 may also communicate with other users 10, e.g., regarding a game, wager, and/or financial indicator.

Server 2 may comprise one or more processors, computers, computer systems, computer networks, and or computer databases. The one or more processors may execute software instructions, e.g., stored on computer-readable media, to perform the computer-implemented steps described herein. Server 2 may comprise modules 18-64. Server 2 may also comprise one or more databases, such as databases 80. Server 2 may communicate with users 10, and data providers 8. For instance, server 2 may communicate with a user 10 computer, such as a browser of a user computer, e.g., over the internet.

Server 2 may comprise a computer system, a processor, central server, or other information processing and communication system described herein. Server 2 may comprise a management system for managing, tracking, and/or ensuring compliance of one or more loans and/or insurance policies.

It should be appreciated that the various communications described herein, e.g., from system to another party such as a user, may occur via user interface, printed letter, automatic telephone call, email, SMS, text messaging, notifications via website, FTP, via Facebook, twitter, or other means of communication. For example, when server 2 communicates with a user such as an analyst or borrower, it may cause information to be displayed on a user interface, or in some embodiments it may cause a paper letter to be mailed to a borrower.

It should be appreciated that features described for a “system” as described below may also apply to server 2.

Databases 80 may comprise one or more processors, computers, computer systems, computer networks, and/or computer databases configured to store information. Each of databases 80 may communicate with server 2, e.g., via one or more modules of server 2. For instance, server 2 and modules may store information in databases 80 and may also use information stored in databases 80.

Users 10a-10n may comprise one or more human persons, one or more user workstations, and/or one or more hardware or software modules that interact with other users and/or central server. Users may comprise traders, trader workstations, and other trading entities. Users 10 may interact with server 2, and/or other users 10. As used in this application, users 10a-10n may also refer to a user's interface to other system 300 components (like server 2), such as a user's PDA or computer or a program running on a user's computer such as a computer web browser like Internet Explorer™, which may communicate with data providers 8 and/or server 2.

In some embodiments, a user may comprise a loan portfolio manager who tracks the status of loans. In some embodiments, a user may comprise one or more (or representatives of one or more) of the following: a borrower (e.g., of a particular loan), a lender for a particular loan, a title holder for a loan, an insurance provider, an insured entity, a prospective purchaser (or seller) of one or more loans, properties, or portfolios, an investor (e.g., who holds a portfolio of loans), an analyst (e.g., an insurance compliance analyst), a system moderator, a compliance officer, a risk officer, a manager, or other person or entity.

Data provider(s) 8 may comprise any person, processor, information service, or other entity that publishes or otherwise provides information concerning one or more loans and/or other financial instruments, to server 2, and/or users 10.

Data provider 8 may provide information to users, server, databases, and/or other data providers concerning one or more of the following: one or more loans, residential properties, commercial properties, one or more leases, one or more insurance policies, one or more portfolios of loans and/or insurance policies, one or more compliance issues, one or more exceptions, other financial instruments, and other information. Information relating to a loan or insurance policy may comprise a borrower, loan number, product type, current balance, originator, property type, property address, property name, policy number, information about coverage or coverage type (e.g., including exclusions such as for terrorism, mold, wind, flood, earthquake), insurance carrier ratings, policy number, effective date, expiration date, insurance company, coverage amount, deductible, coverage required, borrowing entity name, mortgagee/loss payee clause, mortgagee endorsement, loss payee endorsement, additional named insured clause, additional named insured endorsement, compliance items, information about reminders, status information, payment information, whether or not an item is active, whether or not an item is cancelled, information about collateral (such as collateral name and address), relevant analyst, information about one or more exceptions, alerts, and other information, as well as any information used to determine any of the above. Information about an exception, such as a policy level exception, may comprise information about cancellation (e.g., 10 days or 30 days' notice of cancellation), 12-month policy term, accord 28, accord 25, information about unacceptable language on accord form, mortgage/loss payee clause, mortgage endorsement, loss payee endorsement, additional named insured clause, additional named insured endorsement, and other information.

Such information may be provided periodically, in real time, as information first becomes available, or at another time or frequency. Data provider 8 may provide such information in any one or more of a variety of forms and means such as video, audio, text (e.g., stock ticker-type information), or other data that may convey information concerning one or more of the following: one or more loans, residential properties, commercial properties, one or more leases, one or more insurance policies, one or more portfolios of loans and/or insurance policies, other financial instruments, and other information. Data may be provided at a variety of different timings. In some embodiments, data may be provided in periodically, continuously, or continually, e.g., via a data feed (e.g., a stream of data that includes real time updates of event information).

Data providers may comprise entities that provide such information, and may include a borrower of a particular loan, a lender for a particular loan, a title holder for a loan, an insurance provider, an insured entity, a prospective purchaser (or seller) of one or more loans, properties, or portfolios, an investor (e.g., who holds a portfolio of loans), an analyst, a system moderator, a compliance officer, a risk officer, a manager, or other person or entity. In some embodiments, data providers may comprise a third-party enterprise software, a database, or other entity. In some embodiments, data provider may comprise a Servicing System, such as the Enterprise system provided by Midland. It should be appreciated that while “servicing system” is sometimes referred to herein, such described features may also apply to other types of data providers or other system components other than a Servicing System, specifically.

In some embodiments, one or more users may act as a data provider by providing information (e.g., relating to a loan, insurance policy, or compliance issue, etc.) to one or more system components.

The server 2 may comprise a computer, server, hub, central processor, or other entity in a network, or other processor. The server 2 may comprise input and output devices for communicating with other various system 300 elements.

In some embodiments, the server 2 may be comprised in an end user's computer 10, e.g., as a toolbar in a user's web browser or another program running on the user's computer. An exemplary server may have software loaded thereon such that it acts as an Insurance Risk Management Application (“IRMA”) as described herein. It should be appreciated that features described with reference to IRMA may also apply to (or be implemented on or via) other systems and methods described herein, such as system 100 described herein.

As shown in FIG. 1, the server 2 may comprise a plurality of modules, such as modules 22-34. Each module may comprise a processor as well as input and output devices for communicating with other modules, databases, and other system elements.

User interface module 22 may communicate with users and enable users to communicate with server and other users. User interface module 22 may cause information to be output to a user, e.g., at a user output device such as a display device (e.g., a display device at a user terminal), and/or a speaker. For example, user interface module 22 may generate interactive user interfaces. The information outputted to a user may be (or be related to) a user account, one or more loans, loan specifications, loan documents, status, pop-ups, confirmation windows, loan submission indicia, and other information described herein. User interface module may communicate such information electronically, e.g., via networked communication such as the internet (e.g., in an email or webpage), telecommunication service, etc. In some embodiments, user interface module 22 may comprise input devices for users to input information about one or more loans and/or financial instruments, and other information.

User preferences module 24 may receive, identify, or determine user preferences concerning one or more loans or other financial instruments, and other information. For instance, the module may receive the preferences from a user interacting with a user interface. The module may also receive them from an automated user terminal. The module may also determine them based on a program that automatically determines user preferences concerning one or more loans, documents, and other information.

Loan module 26 may determine information about loans, e.g., based on information determined by server and/or received from one or more data providers. For example, loan module may determine information about the status of a loan (e.g., whether a loan is in effect), which documents are available for a loan, which documents are up to date or not up to date for a loan, any documents or information still needed for a particular loan, and other information.

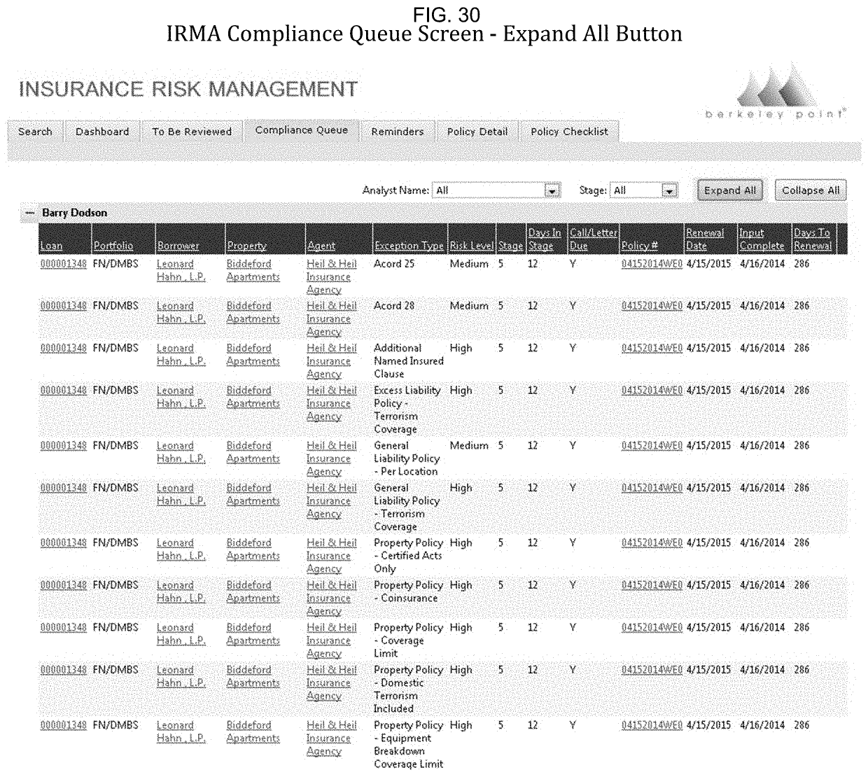

As shown in FIG. 30, a database 80 may be coupled to the server 2. Databases 80 may store information about loans, financial data, and other information. The modules of server 2 may store, access and otherwise interact with various sources of data, including external data, databases and other inputs.

It should be appreciated that any information described to be in any database herein may be queried, processed, stored, modified, requested, displayed, tracked, updated, reported, communicated, etc.

The modules may function separately or in various combinations. While the modules are shown within a single server, the modules may also operate among several servers. The modules may communicate with a plurality of databases, which may also function collectively or separately.

### Exemplary Features

In some embodiments, the system may provide a level of functionality for insurance compliance management and tracking not available in traditional Servicing Systems.

In some embodiments, server 2 may receive a data feed from one or more data provides, such as a servicing system.

In some embodiments, server 2 may comprise a web-based application, e.g., that can run in Internet Explorer (e.g., version 8 and above), Firefox, Chrome, and other browsers.

In some embodiments, server 2 may have some, none, or all of the following requirements: SQL Server 2008 or above; HS 6.0 or above; .NET Framework 4.5.

In some embodiments, new insurance coverage information may be updated in the Servicing System, which may automatically feed to IRMA nightly (or at another frequency or time interval, or continuously or periodically).

In some embodiments, server may create a queue alerting the Insurance Compliance Analysts (or other entity) to perform the compliance review.

In some embodiments, compliance review may be completed by updating the electronic Policy Checklist and/or noting compliance and/or exceptions.

In some embodiments, compliance letters may be generated, e.g., pulling in one or more exceptions that have been raised.

In some embodiments, from the date of the compliance letter, additional queues may be created at specified intervals alerting the analysts to take appropriate action (e.g. and may specify a particular course of action that should be taken, such as calling a borrower via telephone to provide a specific message or to send a letter, which may be auto generated by the system.

In some embodiments, Insurance Risk Management Application (“IRMA”) may be a web application using ASP.NET 4.5 on the front-end and SQL Server 2008 on the back end. In some embodiments, IRMA may use internal and/or external functionality and databases. For example, in some embodiments, server 2 may use local and/or third-party libraries/frameworks to perform one or more of the various tasks:
Enterprise Library—may be used by the Data Layer to access data on SQL Server.
DocX—may be used to construct and modify Microsoft Words letter reports.
EPPlus—this third library may be used to build Excel file. In some embodiments, it may primarily be used to export grid data or Excel format file.
Jquery—may be used by the user interface (“UI”) for client scripting.
AjaxControlToolkit—Microsoft ajax UI controls.
qTip—A jquery plugin is used to display ajax popup/hover on the UI.

### WEB Application Architecture.

The Insurance Risk Management (IRM) solution will use n-layer design architecture. The 3 main layers are IRM.Web, IRM.Business, and IRM.Data. IRM.Common is another project where common code would be used by the other 3 layers/projects.

### Web UI Layer

In some embodiments, user interface (“UI”) controls and forms may reside in a UI layer. This layer may use the ASP.NET Website project type, and the layout of the website is shown in the below in the figures illustrating a user interface. Each of the folders may contain its correspondent file type:
LetterTemplates—this folder contains the predefined letter templates for the reporting. The letters are .docx format. When the user clicks on the Letter reporting button, the application will use DocX library to use the template and construct the letter.
Pages—this folder contains all the ASPX and all other UI files. All data binding and code will be stored in the code-behind files.
Scripts folder—Jquery will be used as the primary client scripting language for accessing the DOM. All Javascript code for the UI will stored in this folder.
Styles—All application styling will be stored in main.css
Master page (Site.Master) is being used to provide the overall application navigation and screen layout and styling.

In some embodiments, ASP.NET forms in the user interface may call the Business objects in IRM.Business project to get the necessary data for displaying on the screens.

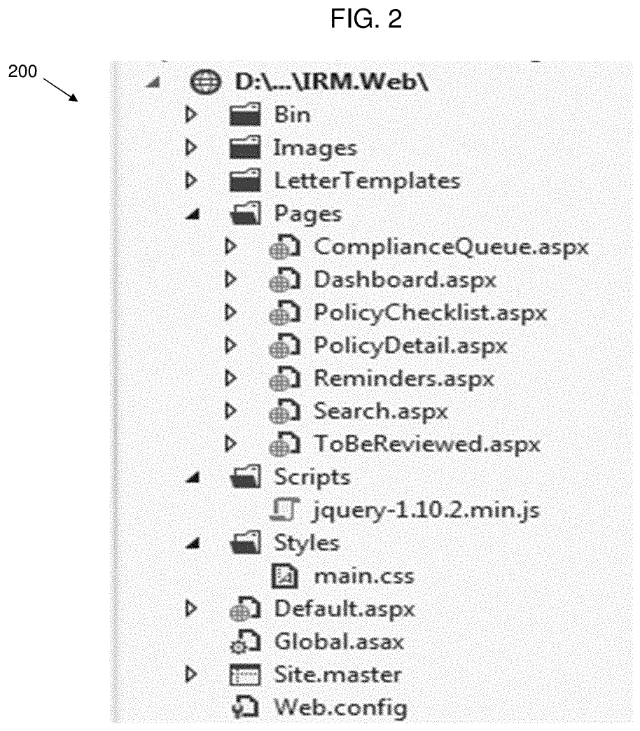

FIG. 2 depicts an exemplary database configuration according to an embodiment. As shown in FIG. 2, database 200 may comprise various folders and files that may be searched, culled, reviewed, edited, saved, downloaded, uploaded, or otherwise interacted with by various elements of system 100.

### Business Layer

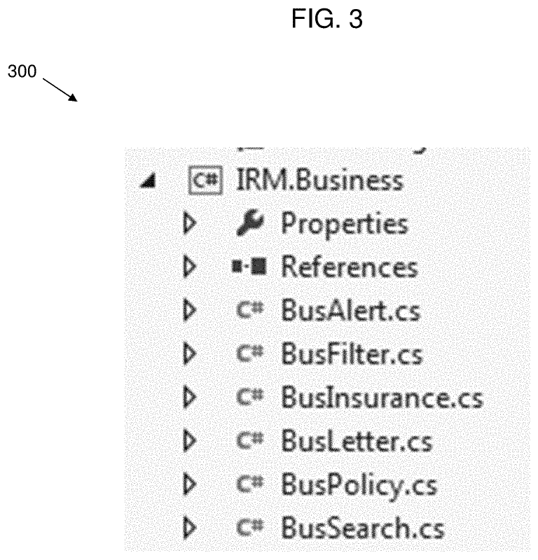

FIG. 3 shows an exemplary business layer 300 of an application according to an embodiment. The business layer of this application is represented by the IRM.Business project. All business logic code of the application will be stored in this layer. Each business class will have a correspondent Data layer class. DataTable and DataSet will be mainly used as data storage objects between the layers. Other data types can also be used as need.
BusInsurance—this class may contain data retrieving methods for one or more of the following screens: Dashboard, To Be Reviewed, Compliance Queue. These screens may only need 1 or 2 select methods, and in some embodiments, it may be efficient to combine them into 1 class.
BusAlert—may contain methods for data retrieval, update, insert for the Reminders screen.
BusPolicy—may contain methods for data retrieval, update, insert for the Policy Detail and Policy Checklist screens.
BusLetter—may contain code for generating the letter reports. In some embodiments, BusLetter may use a third party DocX library to edit the Words letter template files.
BusSearch—may be used by the search screen.
BusFilter—may contains filter select methods for the dropdown and other look-up-based controls.

### Data Layer

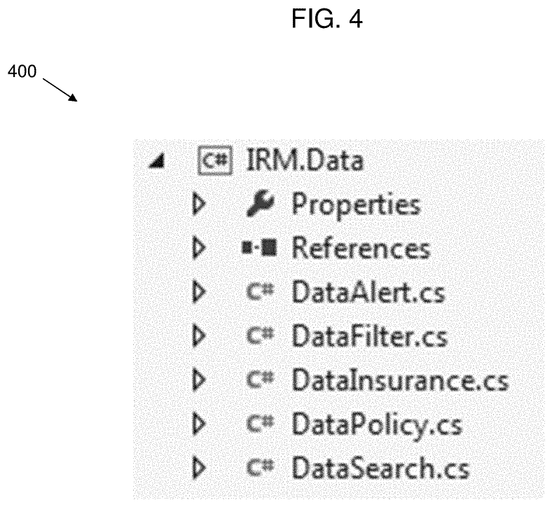

FIG. 4 shows an exemplary data layer 400 of an application according to an embodiment. The code in the SiteVisit.Data project mainly uses Enterprise Library to call stored procedures to select, update, and data to/from database. The Select methods will mainly return DataTable and DataSet data type to the business layer. While Update and Insert takes in DataTable as input data type. Also note that Data layer methods are static, for ease of instantiation and access.
DataInsurance—this class may contain data retrieving methods for the following screens:

Dashboard, To Be Reviewed, and Compliance Queue. These screens may only need 1 or 2 select methods, so in some embodiments it may be efficient to combine them into 1 class.
DataReminder—may contain methods for data retrieval, update, insert for the Reminders screen.
DataPolicy—may contain methods for data retrieval, update, insert for the Policy Detail and Policy Checklist screens.
DataFilter—may contain methods for data retrieval for look-up controls, such as dropdownlist.
DataSearch—may contain methods for the search screen.

### DATABASE

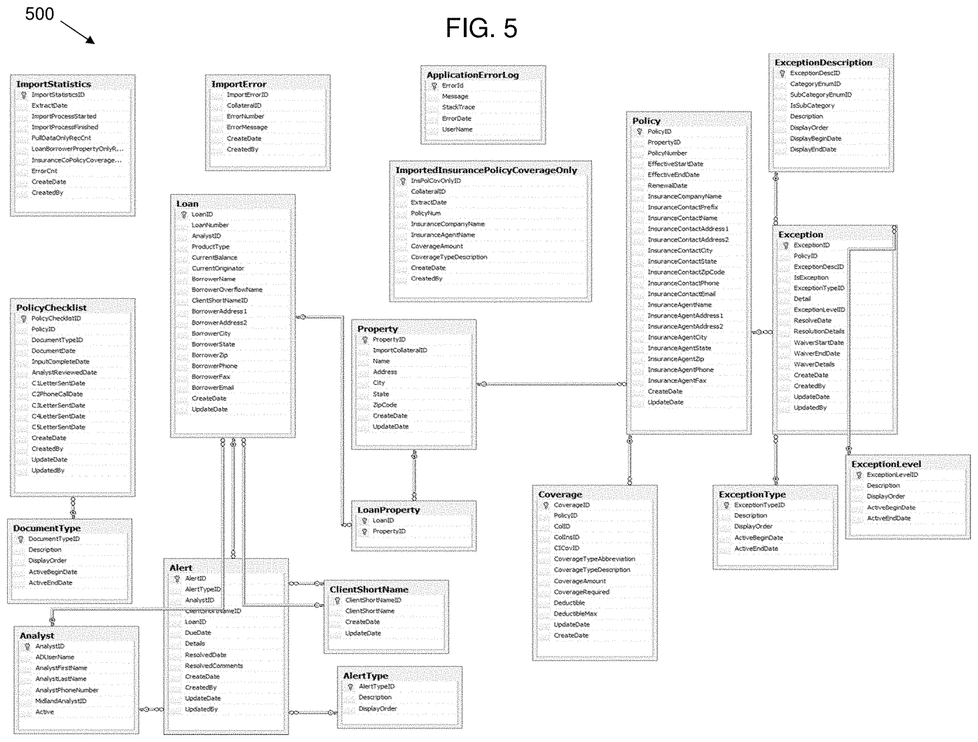

FIG. 5 shows an exemplary database structure 500 according to an embodiment. Exemplary data structures, programs, and routines may also include one or more of the following: import statistics, import error, application error log, exception description, loan, imported insurance policy converage, policy, exception, exception level, exception type, coverage, property, loan property, policy checklist, document type, analyst, alert, client short name, and alert type. Information about each of these items (e.g., as described in FIG. 5) may be stored in the database.

Exemplary data structures, programs, and routines may also include one or more of the following:

### Stored Procedures

### Search Screen

uspSearchCustomuspAnalystAlertCountSelect
uspAnalystAlertCountSelect

### Dashboard

uspDashboardSelect

### To Be Reviewed

uspToB eReviewedSelect

### Compliance Queue

uspComplianceSelect

### Reminders

uspAlertTypeSelect
uspAlertSelect
uspAlertsSelect
uspAlertsByClientLoanSelect
uspAlertInsert
uspAlertUpdate
uspAlertDelete
uspAlertResolvedUpdate

### Policy Details

uspPolicyDetailSelect

### Policy Checklist

uspPropertyByPolicyIDSelect
uspEffectiveDateByPolicyPropertySelect
uspPolicyChecklistSelect
uspPolicyChecklistExceptionSelect
uspLetterDataSelect
uspPolicyChecklistSave
uspPolicyChecklistExceptionSave

### Nightly Process

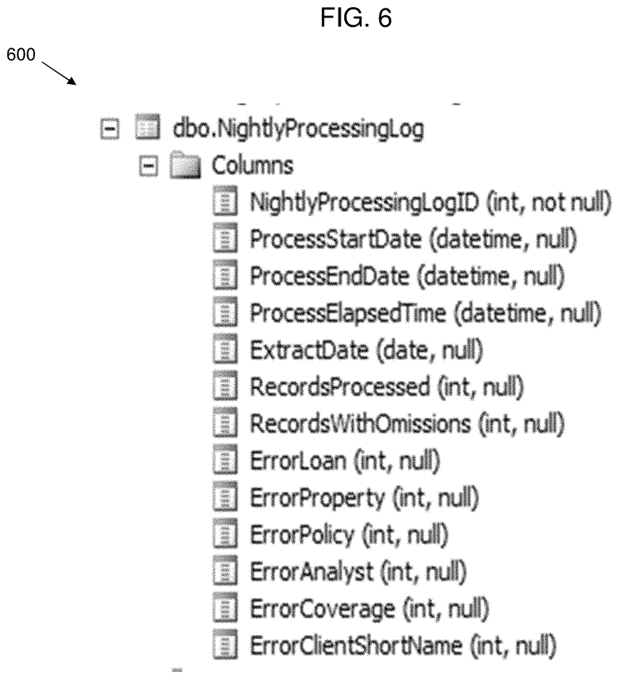

FIG. 6 depicts exemplary nightly process functionality according to an embodiment.

The nightly process may update and/or add data to the IRMA tables, e.g., using the Midland data in BPCDW. Start and end time and record counts may be inserted into the NightlyProcessingLog table.

uspNightlyProcess—Main stored procedure called by SQL Agent Job on DB02 called IRMA.Nightly.Process. The stored procedure in turn calls the following stored procedures:
uspNightlyMidlandDataUpdate
uspNightlyDataUpdate
uspNightlyOmissionsUpdate
and updates the NightlyProcessingLog table

Nightly Step 1. uspNightlyMidlandDataUpdate—may retrieves data from BPCDW, e.g., based on the ExtractDate, and may insert the data into the NightlyMidlandProcessing table. In some embodiments, if the ExtractDate is not passed, the most recent LastExtractDate in BPCDW.dbo.sysoptions may be used to retrieve the rows.

The stored procedure may retreive data from the following BPCDW tables, for example:
ColInsCoverageExtract
DBorrower
DInsuranceSpecialist
ExtractColIns
ExtractLoan
ExtractProperty
ExtractPropertyEntity
FAssetManagement
MacroRef

Nightly (or other periodic) Step 2. uspNightlyDataUpdate—may insert into and/or update IRMA tables with data from the NightlyMidlandProcessing table.

In some embodiments, the process may avoid deleting any records. (In other embodiments, it may delete records.) Updates may be completed before inserts.

After records are added/updated, the corresponding IRMA table primary key may be updated, e.g., in NightlyMidlandProcessing. (eg. [IRMAnalystId], [IRMClientShortNameId])

In some embodiments, IRMA tables affected may include:
ClientShortName—Insert Only
   May look for match on
      ClientShortName.
      Only takes NightlyMidlandProcessing records where ClientShortName is not null
Property—Update/Insert
   May look for match on
      Property. [ImportCollateralID]=NightlyMidlandProcessing. [CollateralID]
Analyst—Update/Insert
   May look for match on
      Analyst. [MidlandAnalystID]=NightlyMidlandProcessing. [InsuranceAnalystEnterpriseID]
Loan—Update/Insert
   May look for match on
      loan.LoanNumber=NightlyMidlandProcessing.[LoanID]
      An example of a LoanNumber/LoanID is 000000575
Policy—Update/Insert
   May look for match on
      Property. [PolicyNumber]=NightlyMidlandProces sing. [IPPolicyNum]
      AND Property.[PropertyID]=NightlyMidlandProcessing. [IRMPropertyId]
      AND Property.[EffectiveStartDate]=NightlyMidlandProcessing. [IPB egDt]
      AND Property.[EffectiveEndDate]=NightlyMidlandProcessing. [IPEndDt]
Coverage—Update/Insert
   May look for match on
      Coverage. [PolicyID]=NightlyMidlandProcessing. [IRMPolicyId]
      AND Coverage. [ColID]=NightlyMidlandProcessing. [CollateralID]
      AND Coverage. [ColInsID]=NightlyMidlandProcessing. [ColInsID]
      AND Coverage. [CICovID]=NightlyMidlandProcessing. [CICovID]
LoanProperty—Insert ONLY
   May look for match on
      LoanProperty. [LoanID]=NightlyMidlandProcessing. [IRMLoanID]
      AND LoanProperty.[PropertyID]=NightlyMidlandProcessing.[IRMPropertyID]

Nightly Step 3. uspNightlyOmissionsUpdate—Adds records without IRMA keys into the NightlyMidlandProcessingOmissions table. Records in the NightlyMidlandProcessing table where any of the following columns are NULL are added:
IRMAnalystId
IRMClientShortNameId
IRMCoverageId
IRMLoanId
IRMPolicyId
IRMPropertyId

This table may be truncated each day. The results can be viewed in one or more reports, such as IRMA Nightly Omissions.

### Reports

In some embodiments, some or all reports may be stored in Reporting Services on RRAC01-DB02. They can be accessed for editing in a file folder.

In some embodiments, some or all report stored procedures may be in the IRMA database.

### IRMA Client Exceptions

Description: may list all exception for a given Client Short Name
Report Name: IRMA Client Exceptions
Parameters: ClientShortNameId INT
Stored Procedure Name: IRMA dbo.rptClientExceptions
Accessed through: ViewPoint

### IRMA Compliance Issues

Description: may list all compliance Issues for each of the 12 months previous and including to the month passed.
Report Name: IRMA Compliance Issues
Parameters: EndDate DATETIME
Stored Procedure Name: IRMA dbo rptComplianceIssues
Accessed through: ViewPoint
Note: dependent on vwLoanPropertyExceptions

### IRMA Exceptions 30 Days Past C1 Notice

Description: may list all exceptions that are still active 30 days after the C1 Notice.
Report Name: IRMA Client Exceptions 30 Days Past C1 Notice
Parameters: None
Stored Procedure Name: IRMA.dbo.rptClientExceptions30DaysPastC1Notice
Accessed through: ViewPoint

### IRMA Forced Placement

Description: Forced Placement records
Report Name: IRMA Forced Placement
Parameters: StartDate DATETIME
Stored Procedure Name: IRMA dbo rptForcedPlacement
Accessed through: ViewPoint

### IRMA Forced Placement Warnings

Description: Forced Placement Warnings records
Report Name: IRMA Forced Placement Warnings
Parameters: NONE
Stored Procedure Name: IRMA dbo rptForcedPlacementWarnings
Accessed through: ViewPoint
Note: dependent on vwLoanPropertyExceptions

### IRMA Nightly Omissions

Description: may list all records in dbo.NightlyMidlandProcessingOmissions. These are records that were not able to be updated/inserted into IRMA tables during the nightly process.
Report Name: IRMA Nightly Omissions
Parameters: NONE
Stored Procedure Name: IRMA dbo rptNightlyDataIssues
Accessed through: ViewPoint (but only available to users listed in ViewPoint
ReportSecurity table—admin users)

### IRMA Policy Checklist

Description: may print Policy Checklist screen in IRMA.
Report Name: IRMA Policy Checklist
Parameters: pPropertyID INT
   pPolicyNumber VARCHAR(25)
   pEffectiveDate DATETIME
Stored Procedure Name(s):
   IRMA.dbo.rptPolicyChecklist
   IRMA dbo rptPolicyChecklistExceptions
Accessed through: The IRMA application on the POLICY CHECKLIST Page
Note: dependent on vwLoanPropertyExceptions
   vwLoanPropertyExceptions

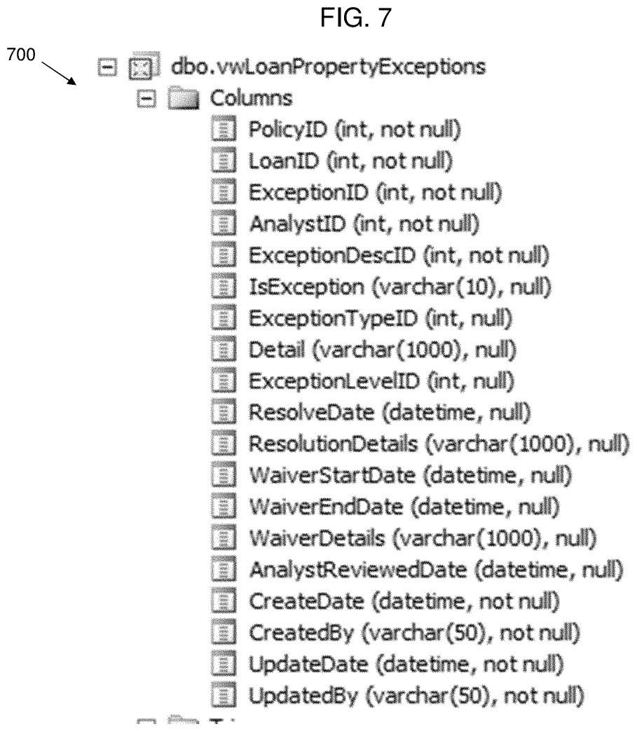

FIG. 7 depicts exemplary loan property exceptions according to various embodiments.

The vwLoanPropertyExceptions may be used by several reports.

In some embodiments, it may pull from the following IRMA tables:
Exception
Analyst
Loan
LoanProperty
Policy
PolicyChecklist

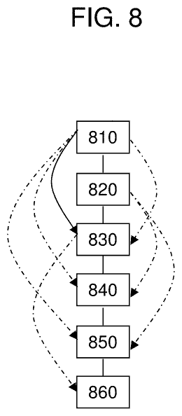

FIG. 8 depicts an exemplary method according to an embodiment.

In block 810, information concerning one or more loans, properties, collateral, borrowers, and other information described herein may be provided, e.g., to server 2, e.g., by one or more users and/or data providers.

In block 820, compliance information may be determined, e.g., by server. For example, server may determine that one or more borrowers need to satisfy one or more requirements, e.g., by a specific date. In another example, server (or user) may determine that a party is in violation of a compliance requirement. In some embodiments, a severity of any violation may also be determined (e.g., on a scale of 1-5, wherein a 1 rating does not incur consequences, a 4 rating may trigger an automatic compliance default notice, and a 5 rating may result in foreclosure or other negative proceedings.

In block 830, additional compliance information may be received, e.g., periodically. Databases storing compliance information may be updated.

In block 840, users such as compliance analysts may track and review compliance information for one or more parties, loans, insurance policies, or other entities, e.g., via server and user interface.

In block 850, users may manually input and update compliance information, e.g., as compliance conditions are satisfied. Server may automatically update databases based on user input.

In block 860, the process may be continually repeated, wherein users and server receive further compliance-related information and track and update compliance requirements.

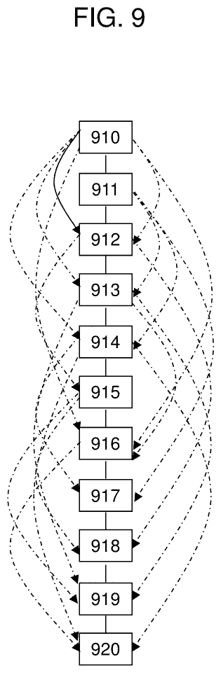

FIG. 9 depicts an exemplary method according to an embodiment.

In block 910, server may receive compliance information from data providers and/or users.

In block 911, server may determine compliance information based on the received information.

In block 912, server may provide compliance tracking features and display (e.g., at a user interface) compliance information, such as a search function at a search tab (e.g., as shown in the Figures).

In block 913, server may provide compliance tracking features and display (e.g., at a user interface) compliance information, such as a dashboard (e.g., as shown in the Figures).

In block 914, server may provide compliance tracking features and display (e.g., at a user interface) compliance information, such as a “to be reviewed” tab (e.g., as shown in the Figures).

In block 915, server may provide compliance tracking features and display (e.g., at a user interface) compliance information, such as a compliance queue tab (e.g., as shown in the Figures).

In block 916, server may provide compliance tracking features and display (e.g., at a user interface) compliance information, such as a reminders tab (e.g., as shown in the Figures).

In block 917, server may provide compliance tracking features and display (e.g., at a user interface) compliance information, such as a policy detail tab (e.g., as shown in the Figures).

In block 918, server may provide compliance tracking features and display (e.g., at a user interface) compliance information, such as a policy checklist (e.g., as shown in the Figures).

It should be appreciated that the tabs and tab functionality may be provided and utilized in any order, multiple times each over time, for one or more loans, insurance policies, borrowers, etc.

In block 919, server may provide compliance tracking features and display (e.g., at a user interface) compliance information, such as export and generate letter functionality (e.g., as shown in the Figures).

In block 920, server may receive updated compliance information from data providers and users. The server may additionally provide compliance tracking features and display (e.g., at a user interface) compliance information, such as any of the functions and features described above, based on the updated information. The process may be repeated as needed for a given borrower, policy, etc. as long as the borrower, policy, etc. is still being tracked by server.

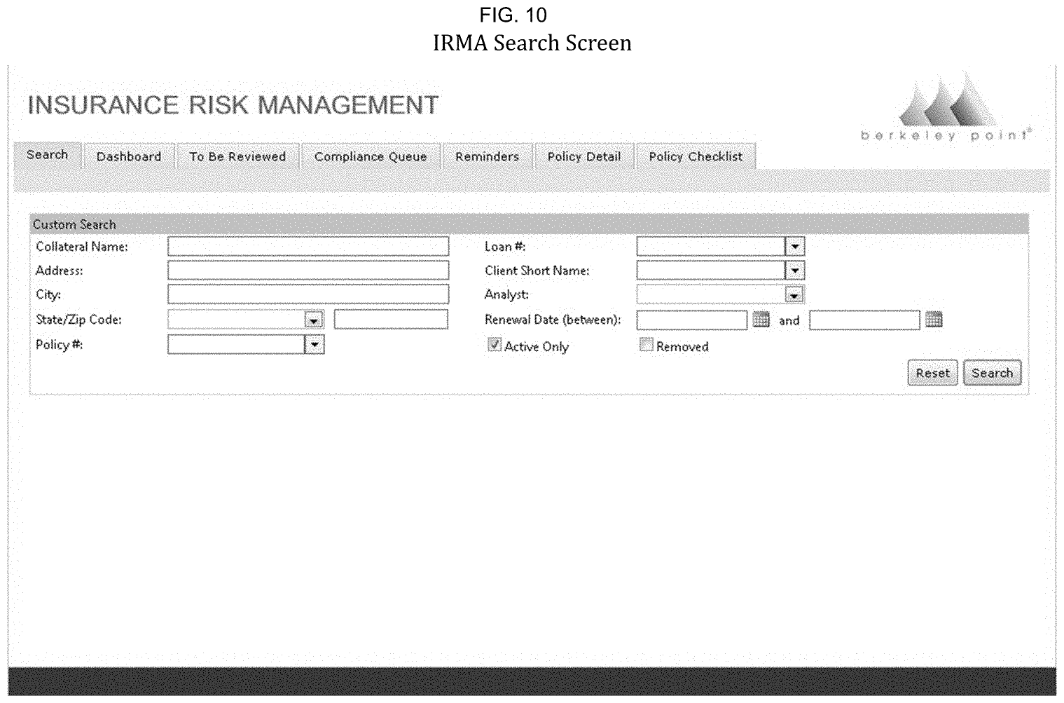

FIGS. 10-21 depict exemplary user interfaces and functionalities of a search tab according to an embodiment. In some embodiments, a Search function may allow for search of all records based on various different search criteria (e.g., as described herein and as shown the Figures).

FIG. 10 depicts an exemplary user interface of an exemplary search tab according to an embodiment.

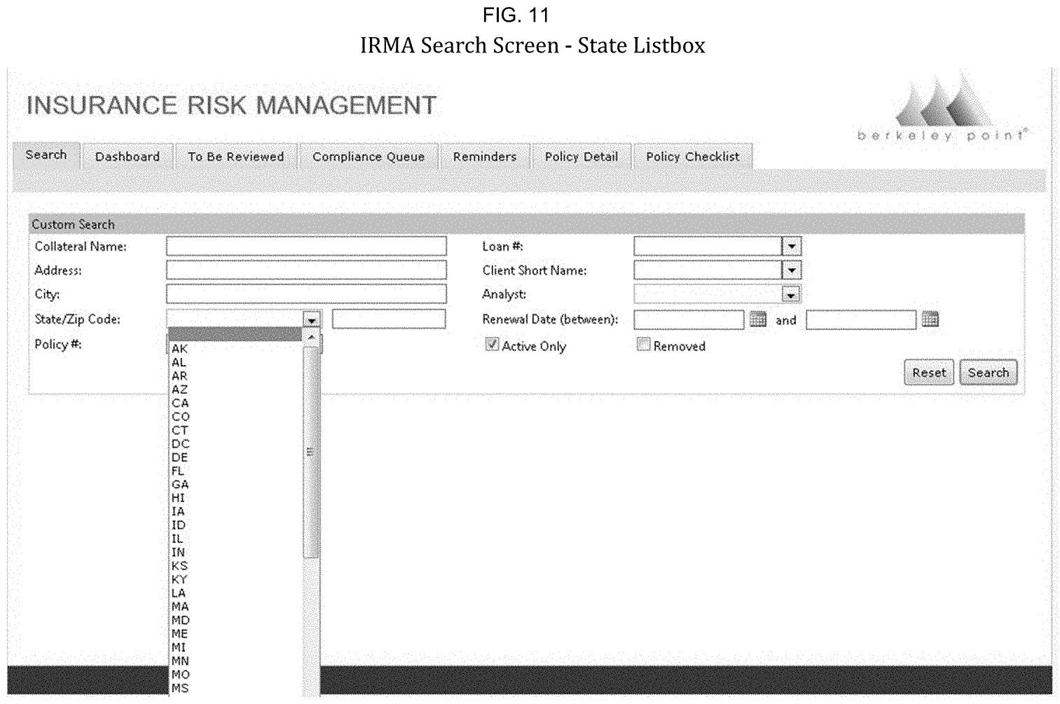

FIG. 11 depicts an exemplary state listbox in an exemplary search tab according to an embodiment.

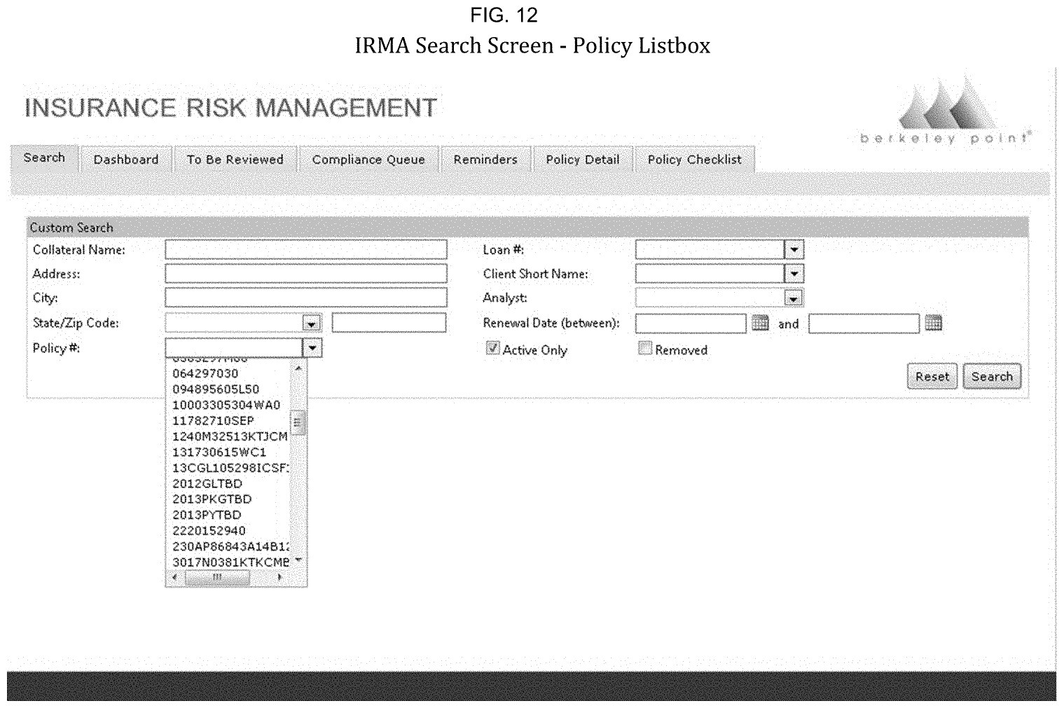

FIG. 12 depicts an exemplary policy number listbox in an exemplary search tab according to an embodiment.

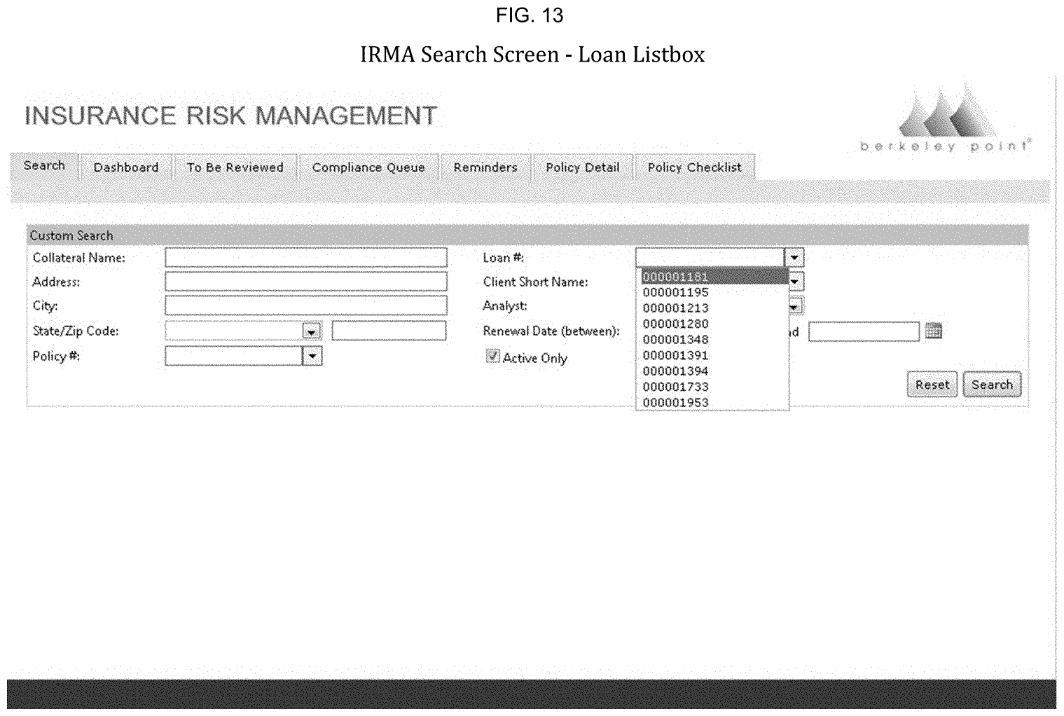

FIG. 13 depicts an exemplary loan number listbox in an exemplary search tab according to an embodiment.

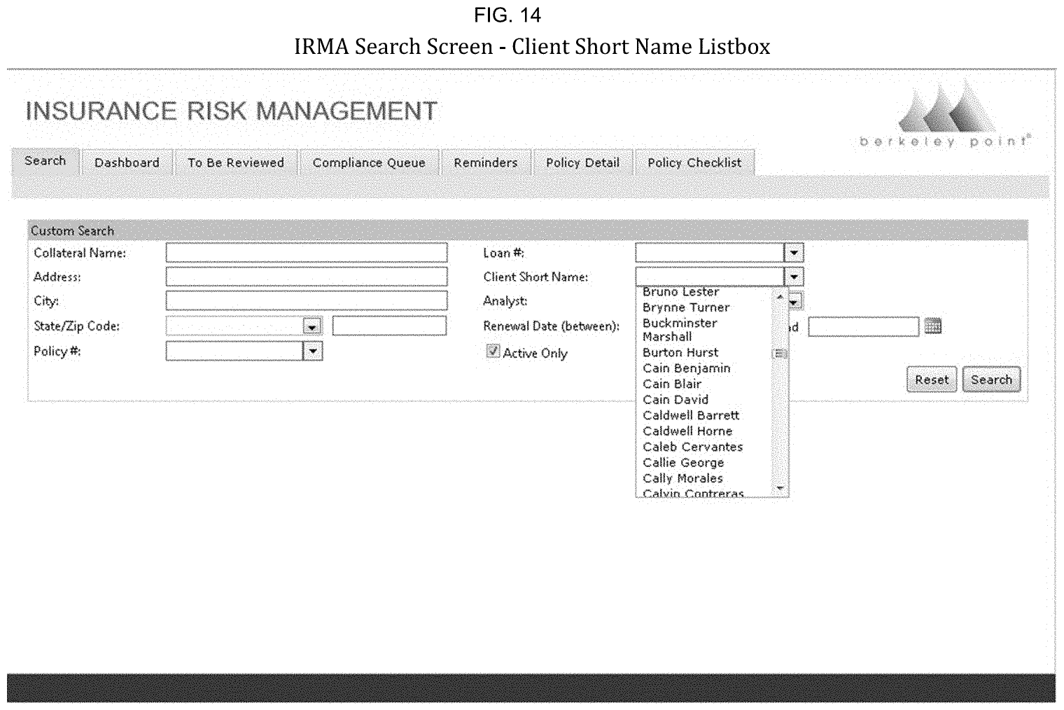

FIG. 14 depicts an exemplary client short name listbox in an exemplary search tab according to an embodiment.

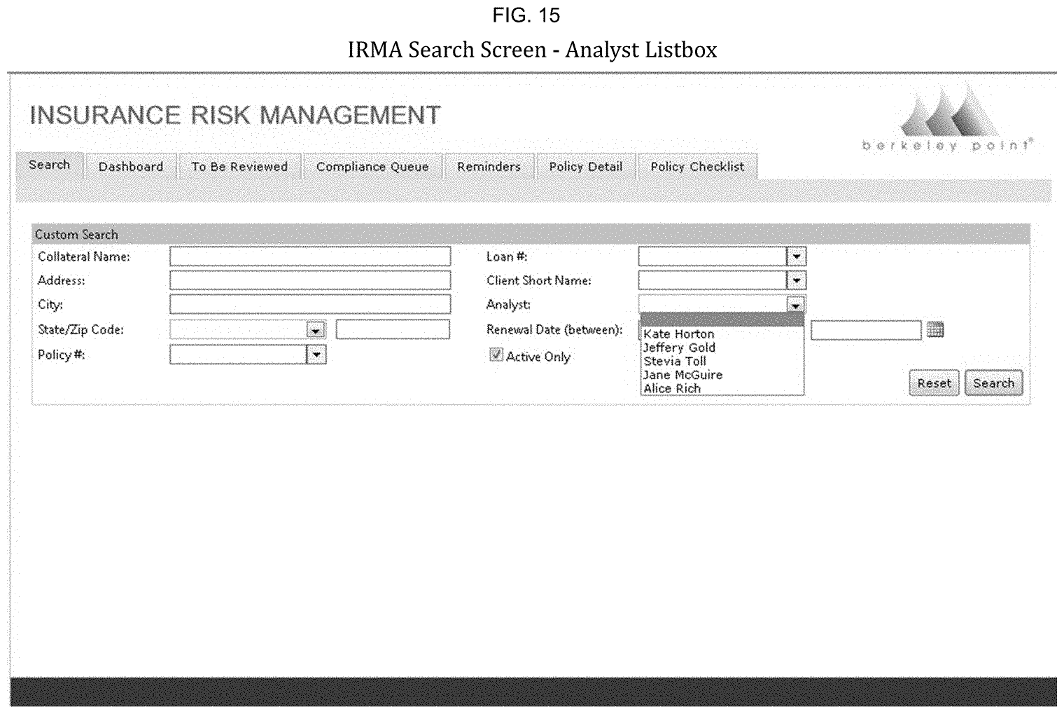

FIG. 15 depicts an exemplary analyst listbox in an exemplary search tab according to an embodiment.

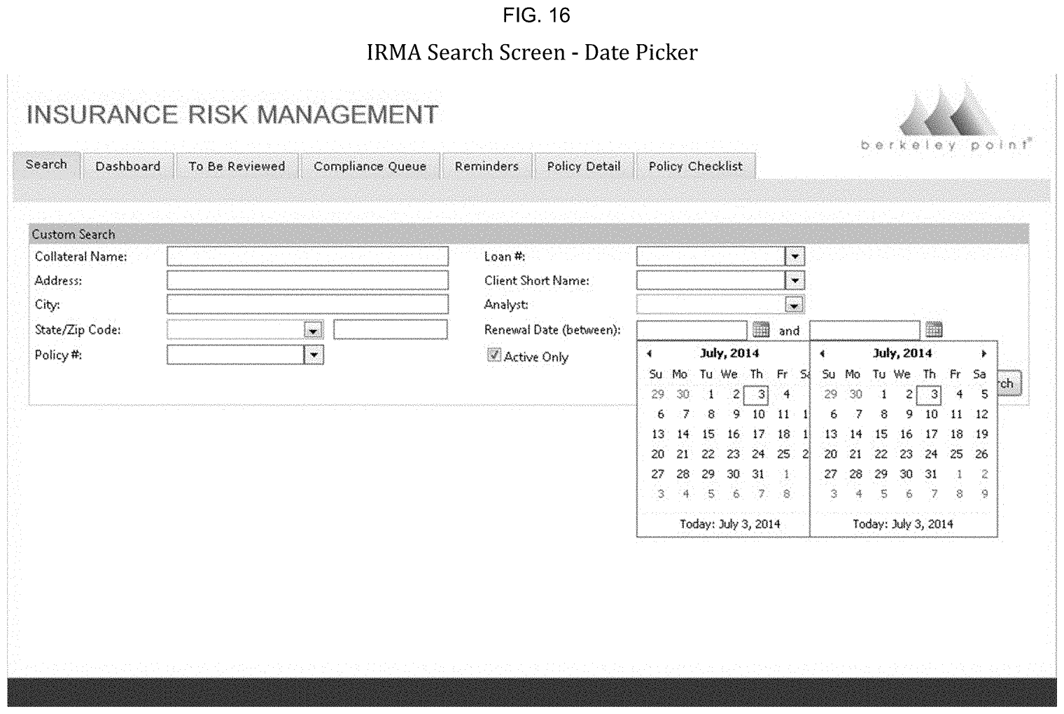

FIG. 16 depicts exemplary date selection indicia in an exemplary search tab according to an embodiment.

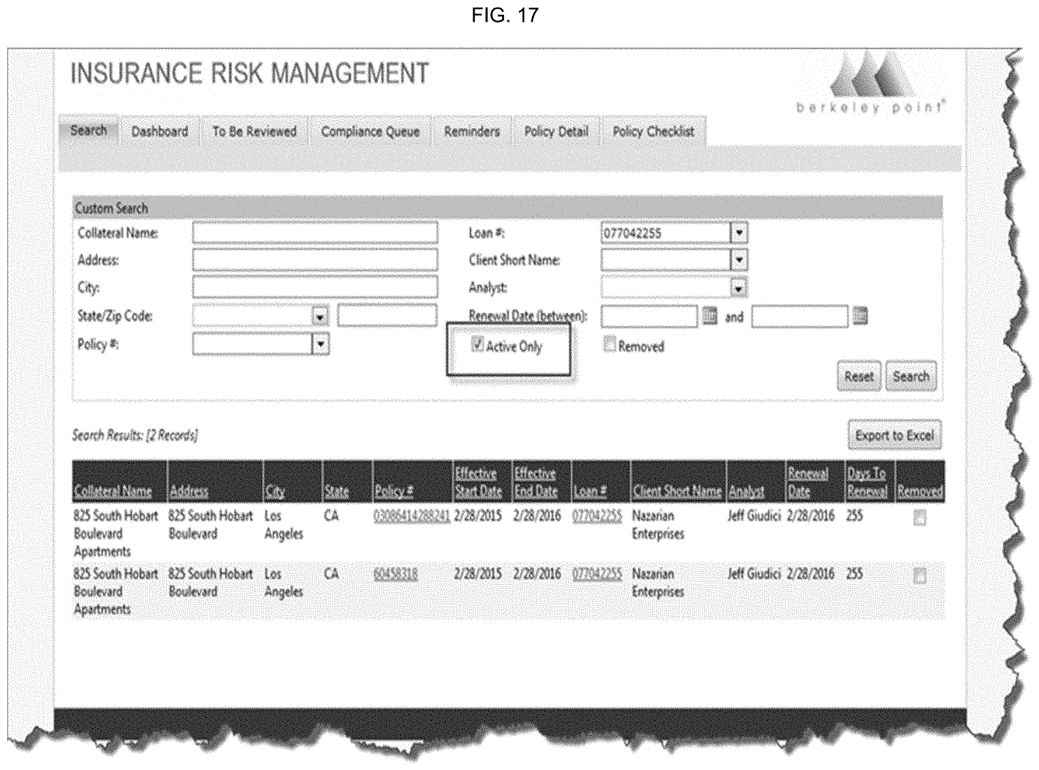

FIG. 17 depicts an exemplary “active only” selection functionality in an exemplary search tab according to an embodiment. In some embodiments, selecting “active only” will cause the system to apply an “active” filter and output and display only those loans that currently have a policy in force.

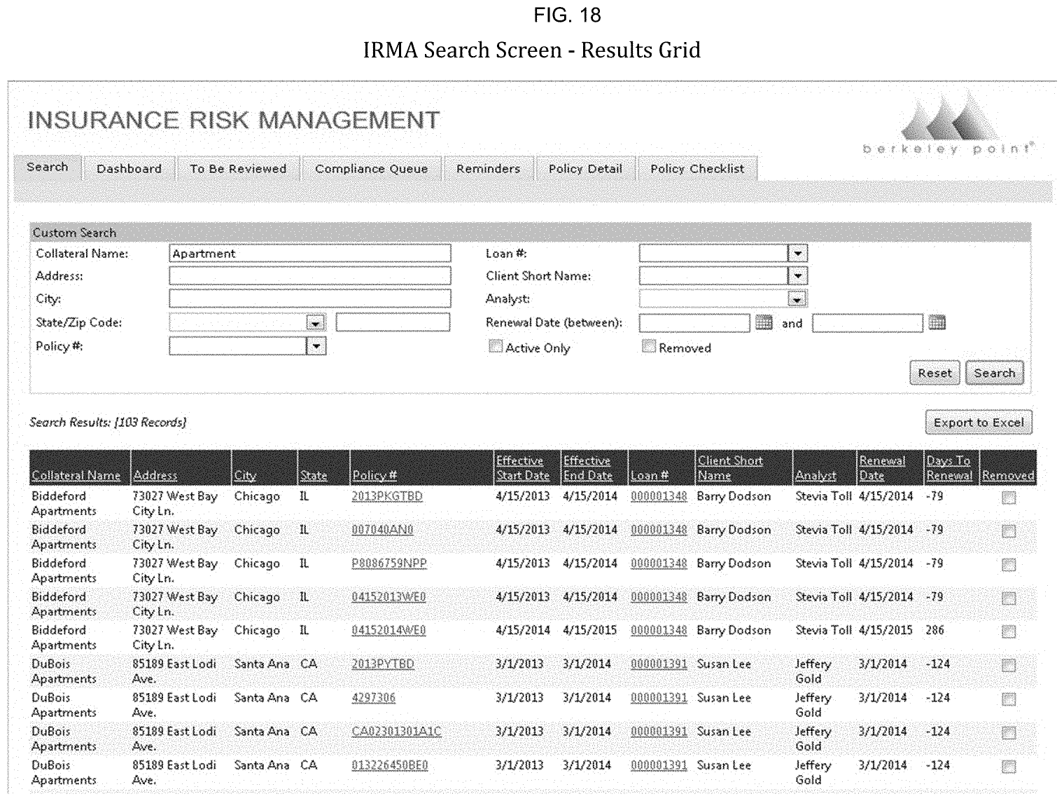

FIG. 18 depicts exemplary search results of an exemplary search according to an embodiment.

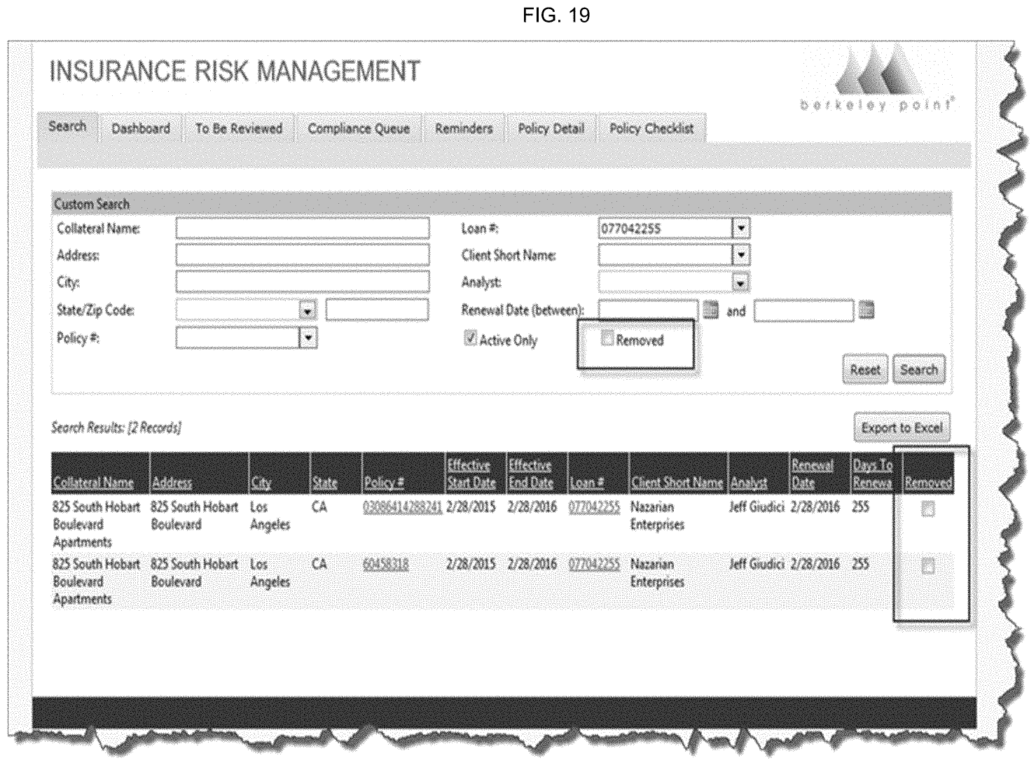

FIG. 19 depicts an exemplary “removed” selectable indicia in an exemplary search tab according to an embodiment. For example, in a search screen tab, a user may select “Removed” (e.g., by checking the “Removed” box) to cause the system to apply a filter and display loans that were previously removed, e.g., from the policy detail screen. In another example, in the search screen tab, a user may de-select “Removed” (e.g., by un-checking the “Removed” box) so that the “removed” policy(ies) will no longer be listed in policy detail screen.

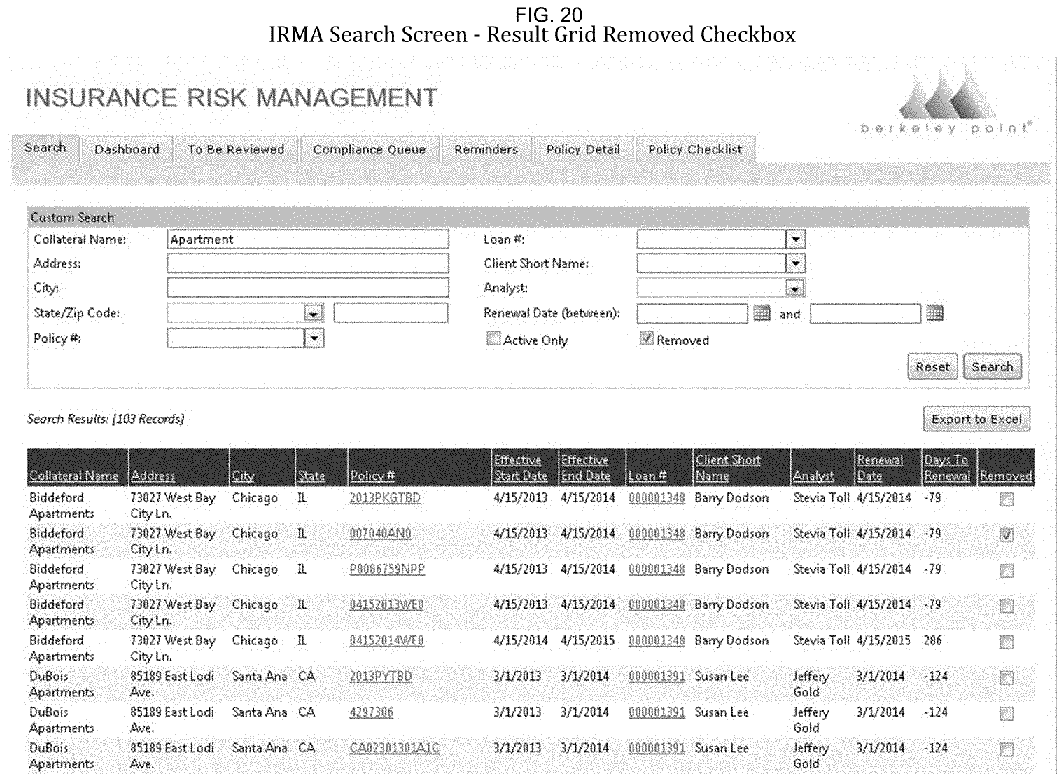

FIG. 20 depicts exemplary “removed” search results according to an embodiment.

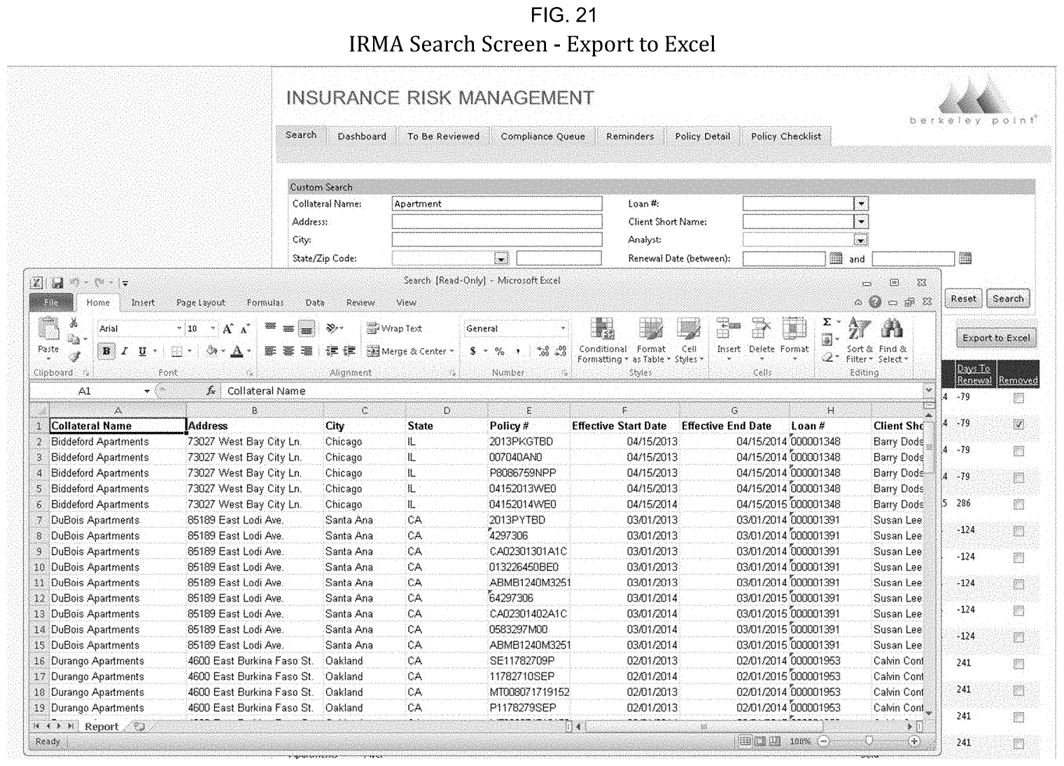

FIG. 21 depicts an exemplary user interface for exporting search results according to an embodiment.

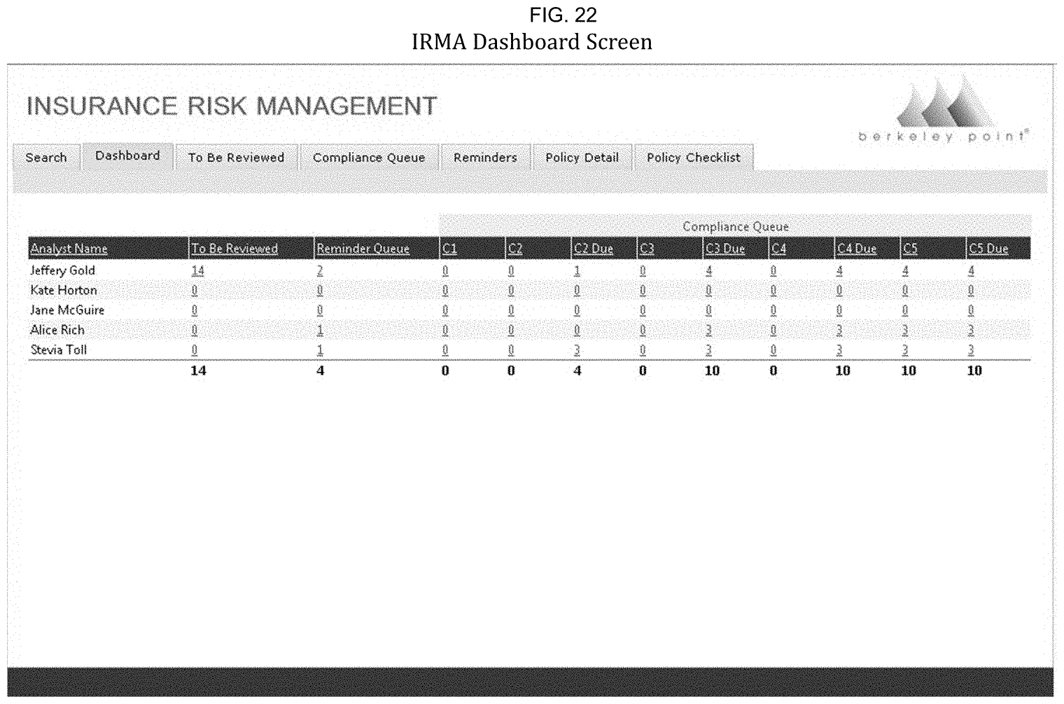

FIG. 22 depicts an exemplary user interface and functionality of a dashboard tab according to an embodiment. In some embodiments, a Dashboard Screen tab may provide an overview of outstanding items in each queue and process stage.

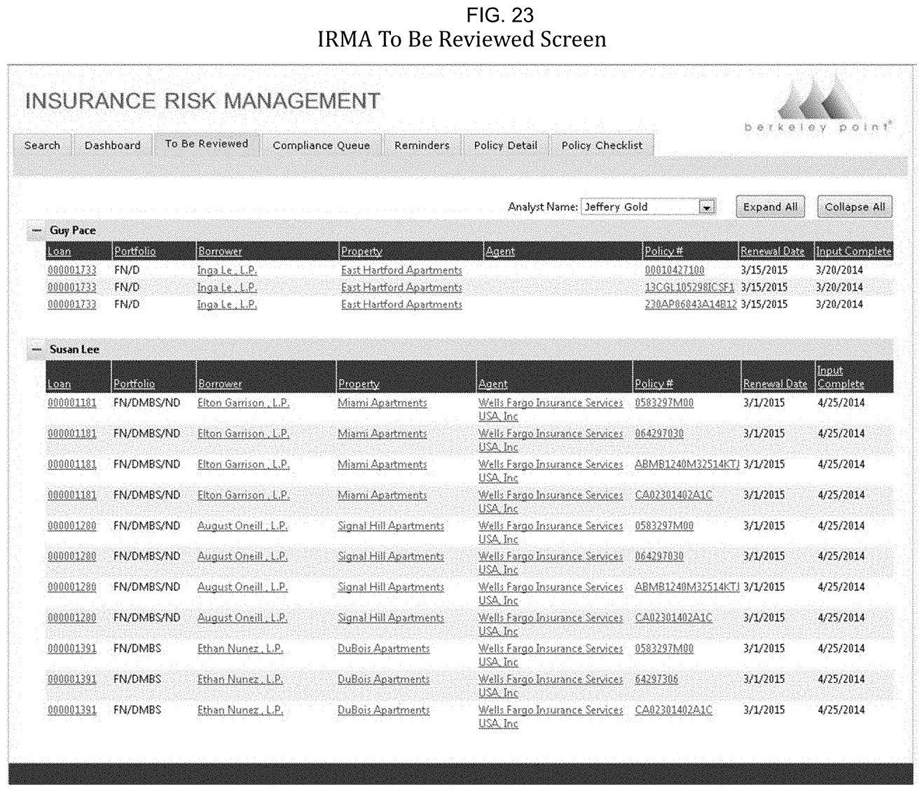

FIGS. 23-26 depict exemplary user interfaces and functionalities of a “to be reviewed” tab according to an embodiment. In some embodiments, a To Be Reviewed tab may provide a list (e.g., sorted by user or client) indicating updated insurance coverage for compliance review.

FIG. 23 depicts an exemplary user interface of a “to be reviewed” tab according to an embodiment.

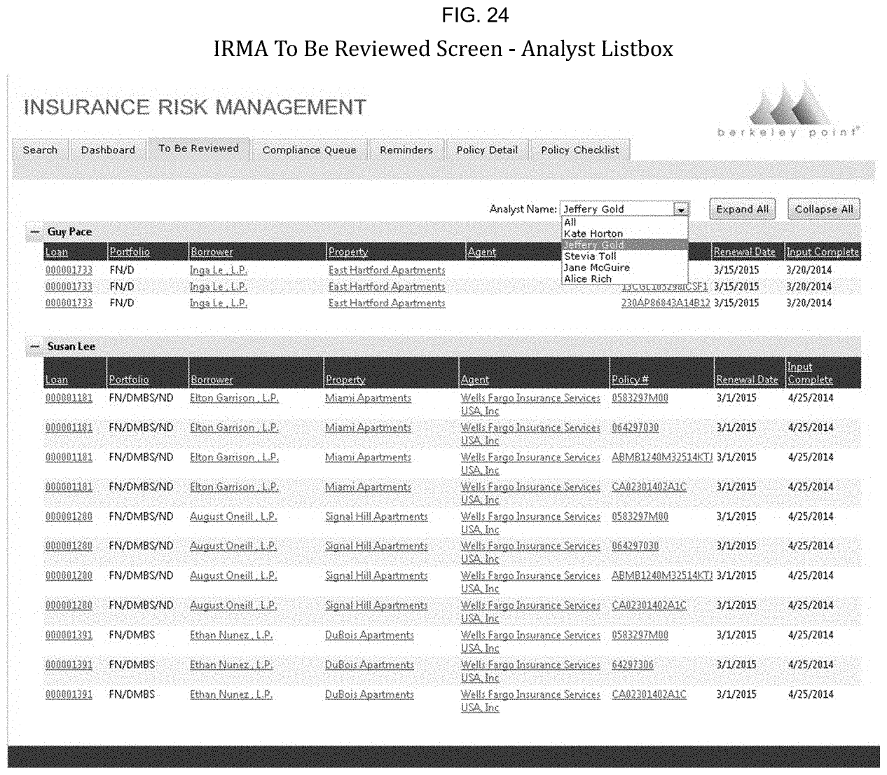

FIG. 24 depicts an exemplary analyst listbox of a “to be reviewed” tab according to an embodiment.

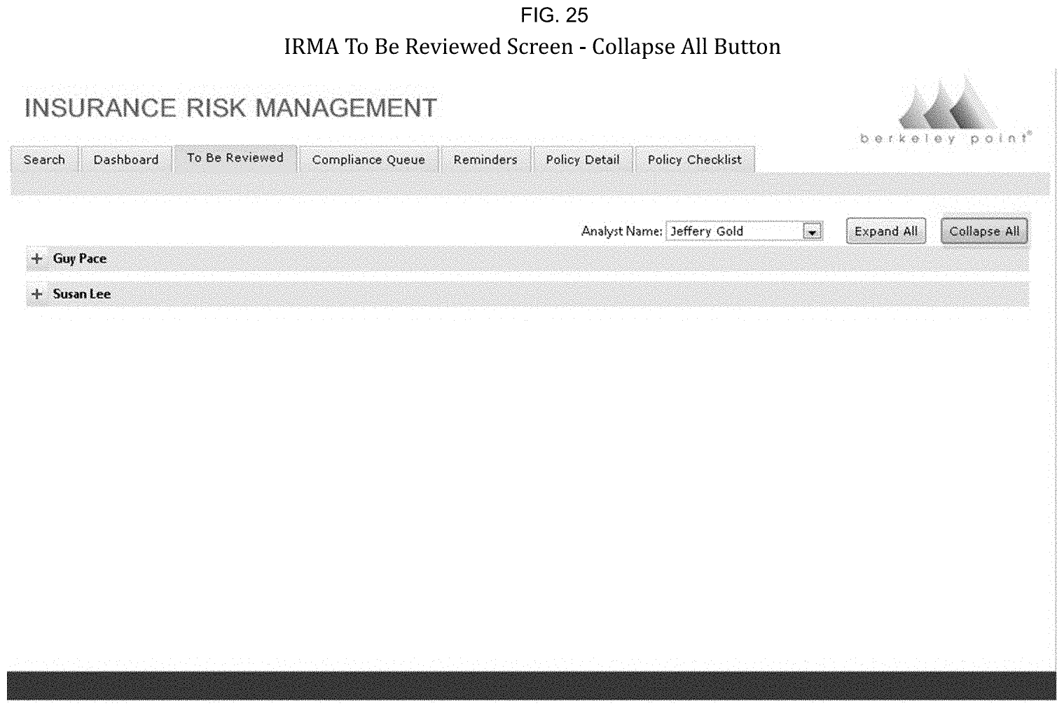

FIG. 25 depicts an exemplary “collapse all” selectable indicia in an exemplary “to be reviewed” tab according to an embodiment.

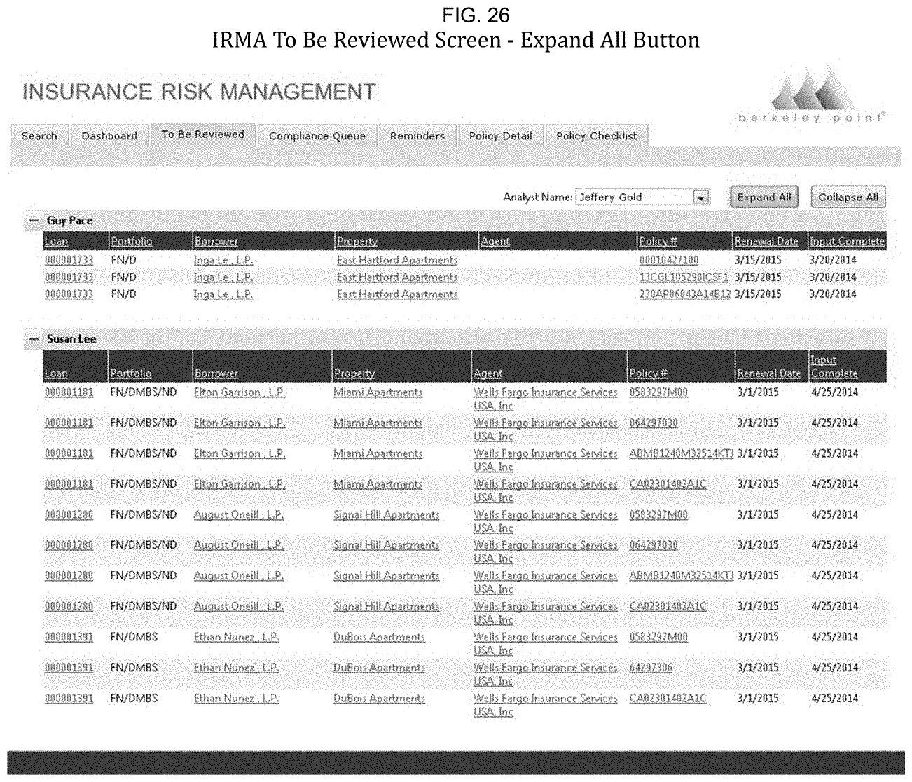

FIG. 26 depicts an exemplary “expand all” selectable indicia in an exemplary “to be reviewed” tab according to an embodiment.

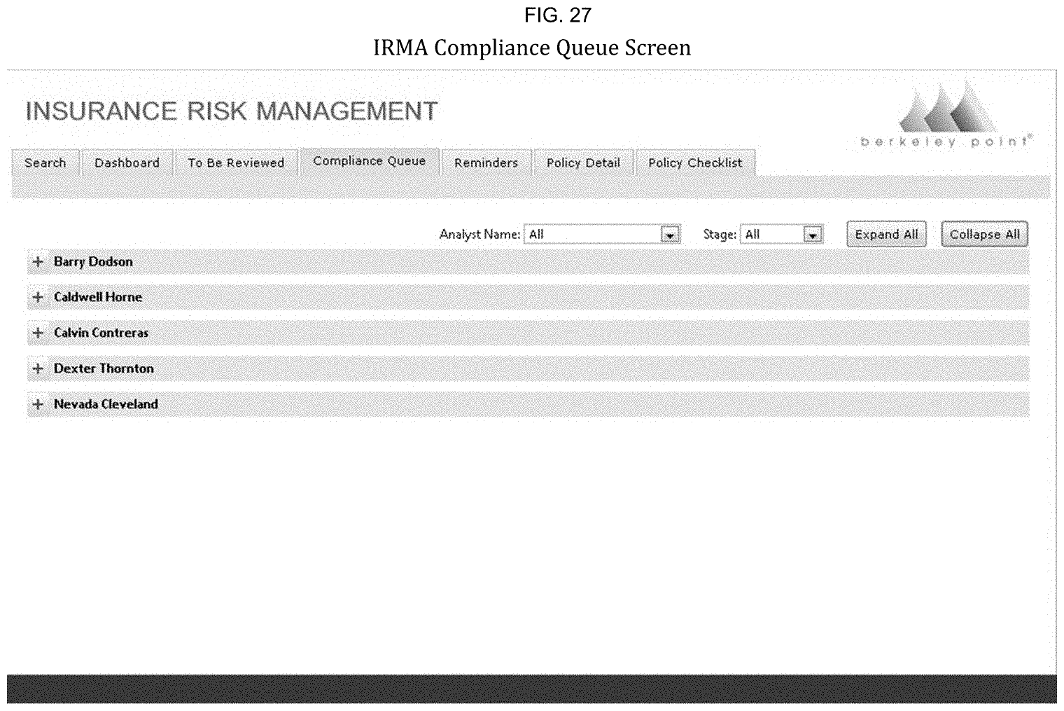

FIGS. 27-32 depict exemplary user interfaces and functionalities of a compliance queue tab according to an embodiment. In some embodiments, a Compliance Queue tab may indicate outstanding compliance issues that may be sorted by process stage.

FIG. 27 depicts an exemplary user interface of a compliance queue tab according to an embodiment.

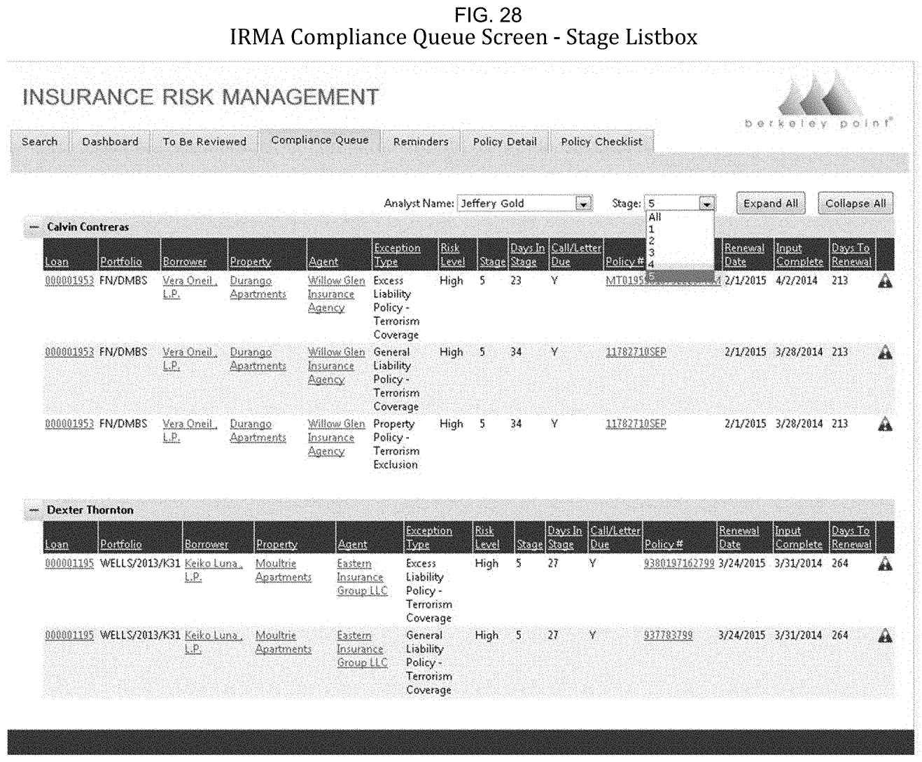

FIG. 28 depicts an exemplary stage listbox in an exemplary compliance queue tab according to an embodiment.

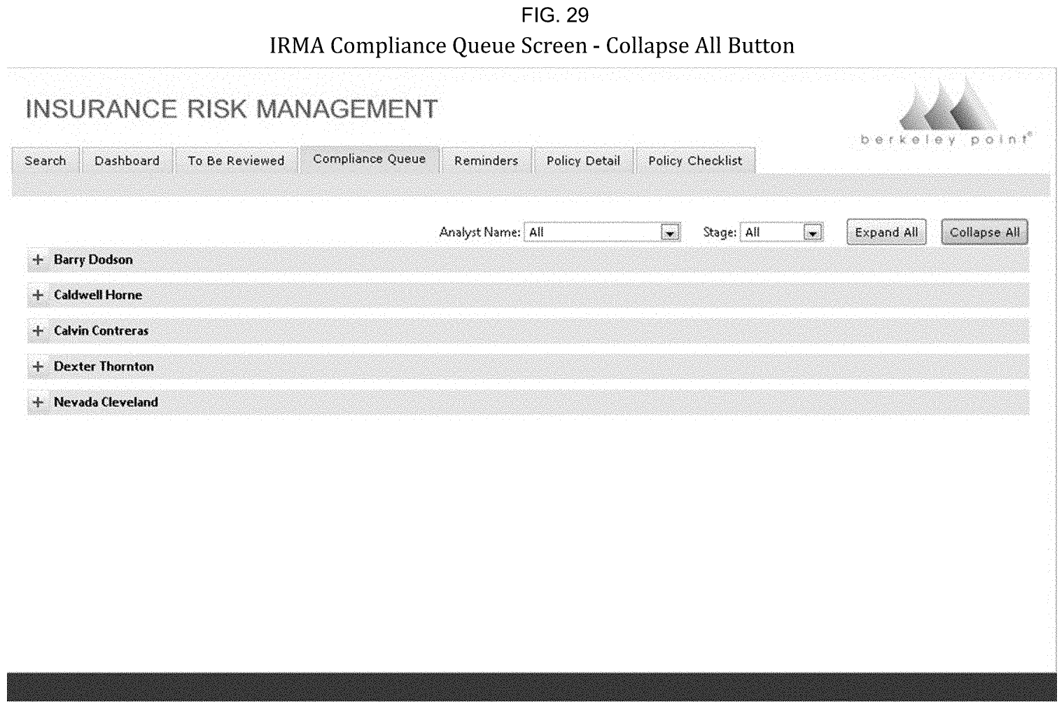

FIG. 29 depicts an exemplary collapse all button in an exemplary compliance queue tab according to an embodiment.

FIG. 30 depicts an exemplary expand all button in an exemplary compliance queue tab according to an embodiment.

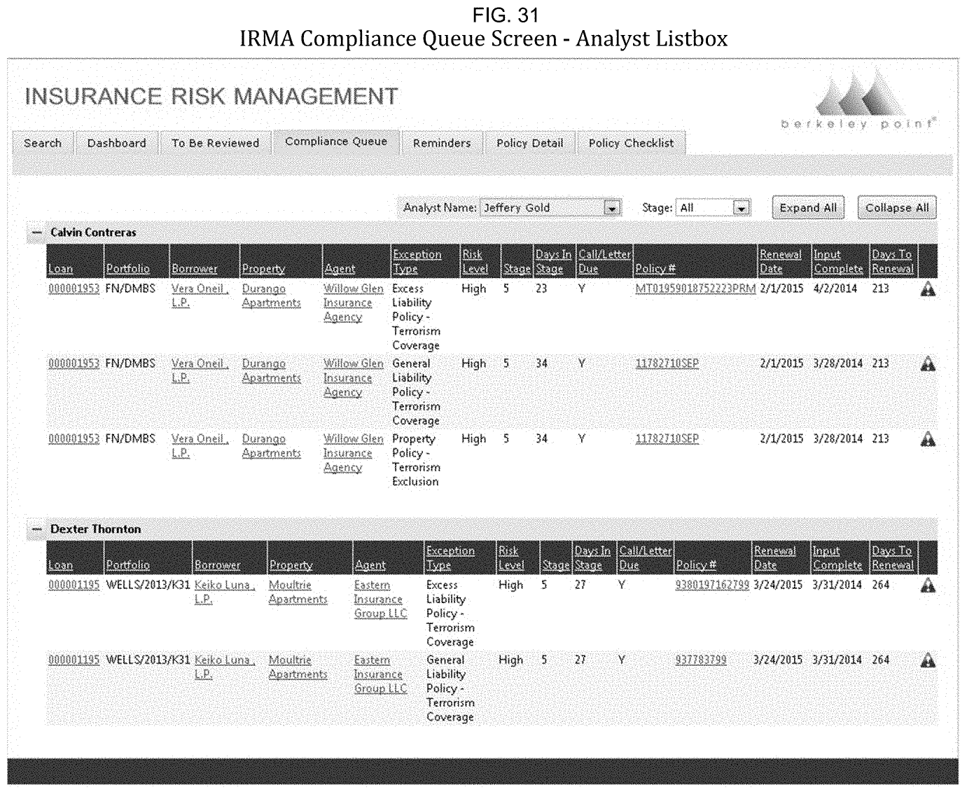

FIG. 31 depicts an exemplary analyst name listbox in an exemplary compliance queue tab according to an embodiment.

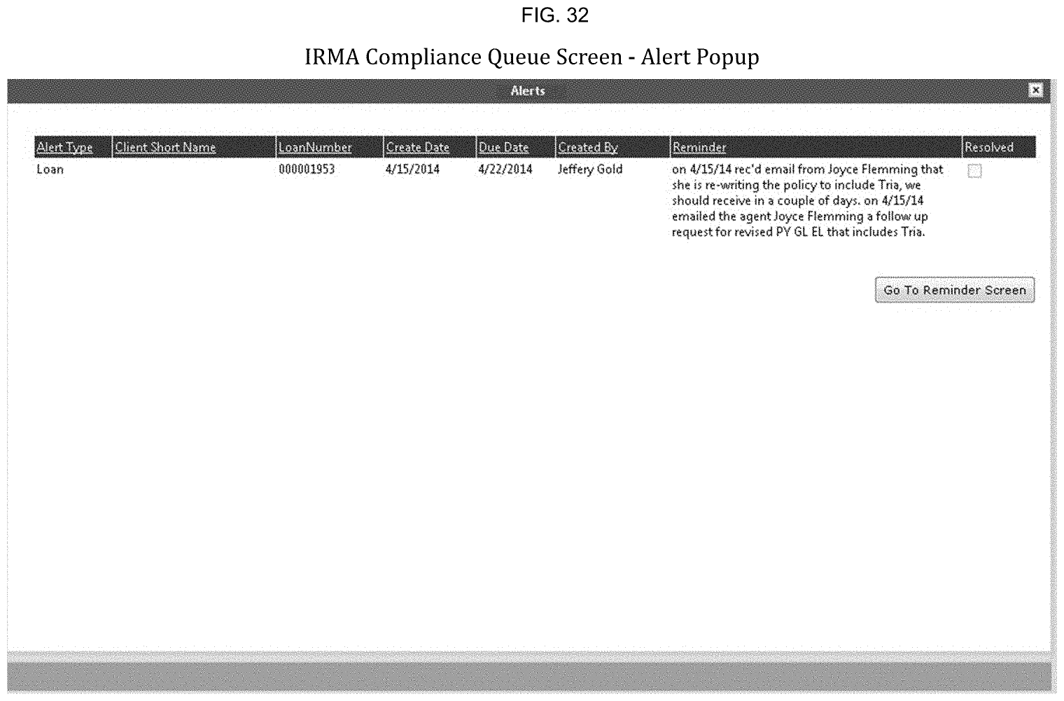

FIG. 32 depicts an exemplary alert popup generated from an exemplary compliance queue tab according to an embodiment.

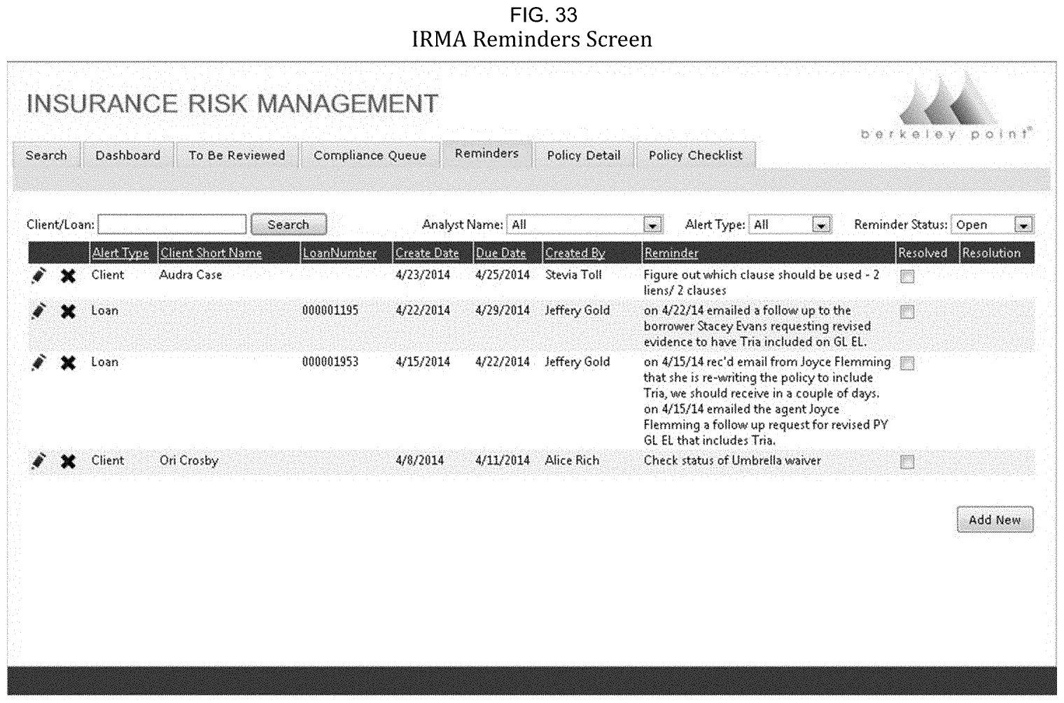

FIGS. 33-38 depict exemplary user interfaces and functionalities of an exemplary reminders tab according to an embodiment. In some embodiments, a Reminders tab may provide notes and alerts (e.g., auto created by the system or created or input by compliance analysts), e.g., for tracking follow up contacts with borrowers and agents. In some embodiments, reminders may remain on the loan history.

FIG. 33 depicts an exemplary user interface of an exemplary reminders tab according to an embodiment.

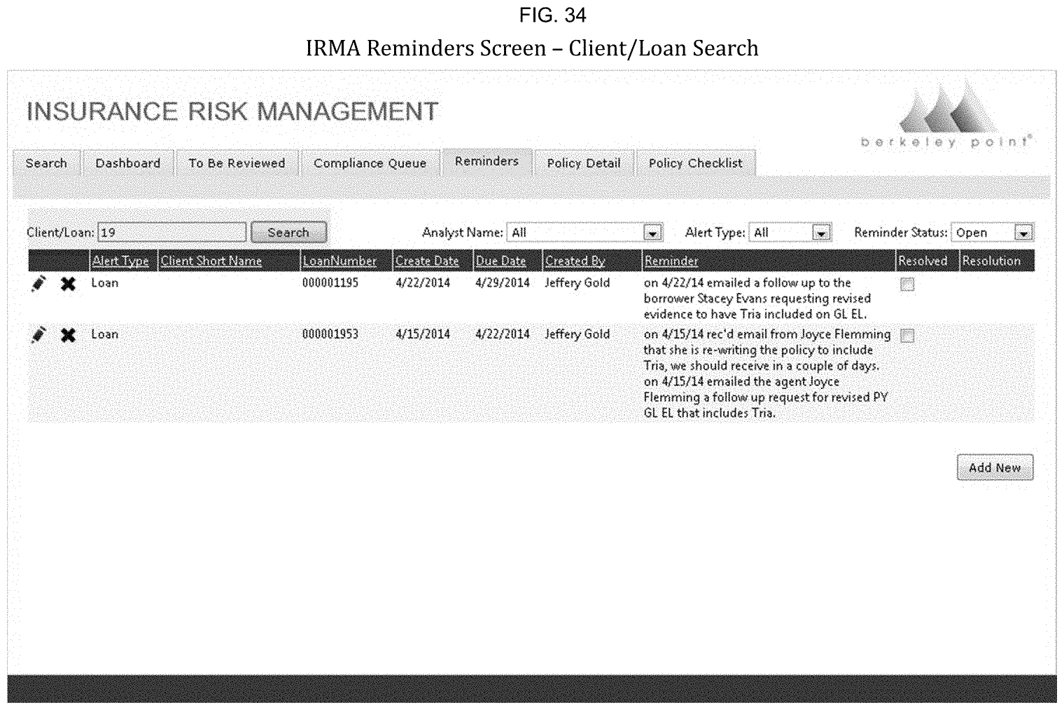

FIG. 34 depicts an exemplary client/loan search box of an exemplary reminders tab according to an embodiment.

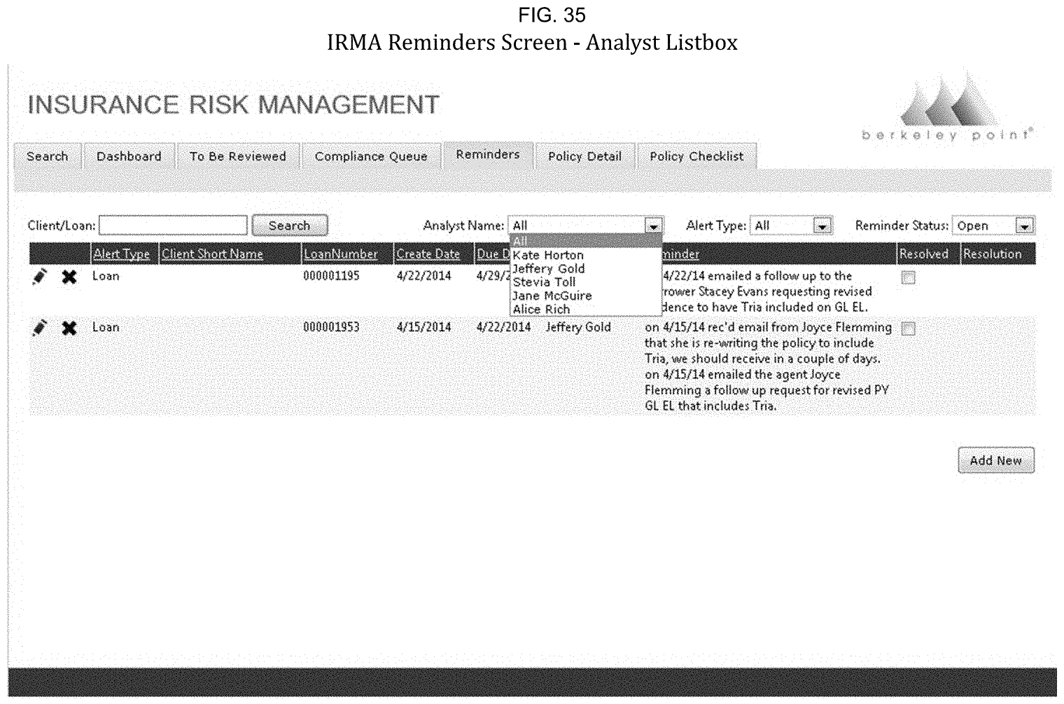

FIG. 35 depicts an exemplary analyst name selection box of an exemplary reminders tab according to an embodiment.

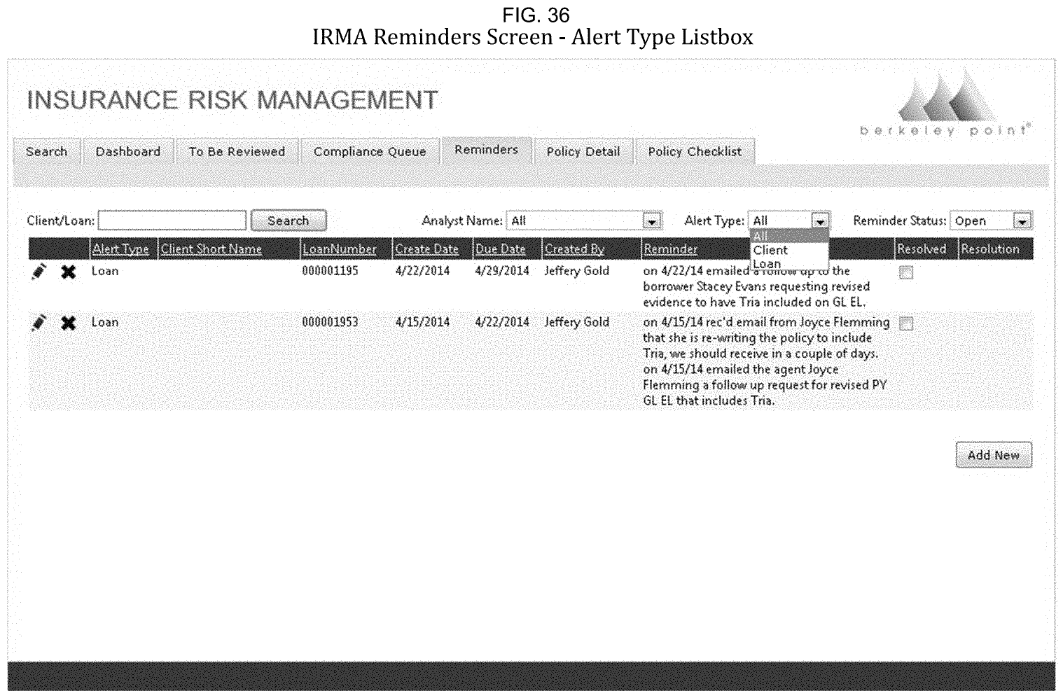

FIG. 36 depicts an exemplary alert type selection box of an exemplary reminders tab according to an embodiment.

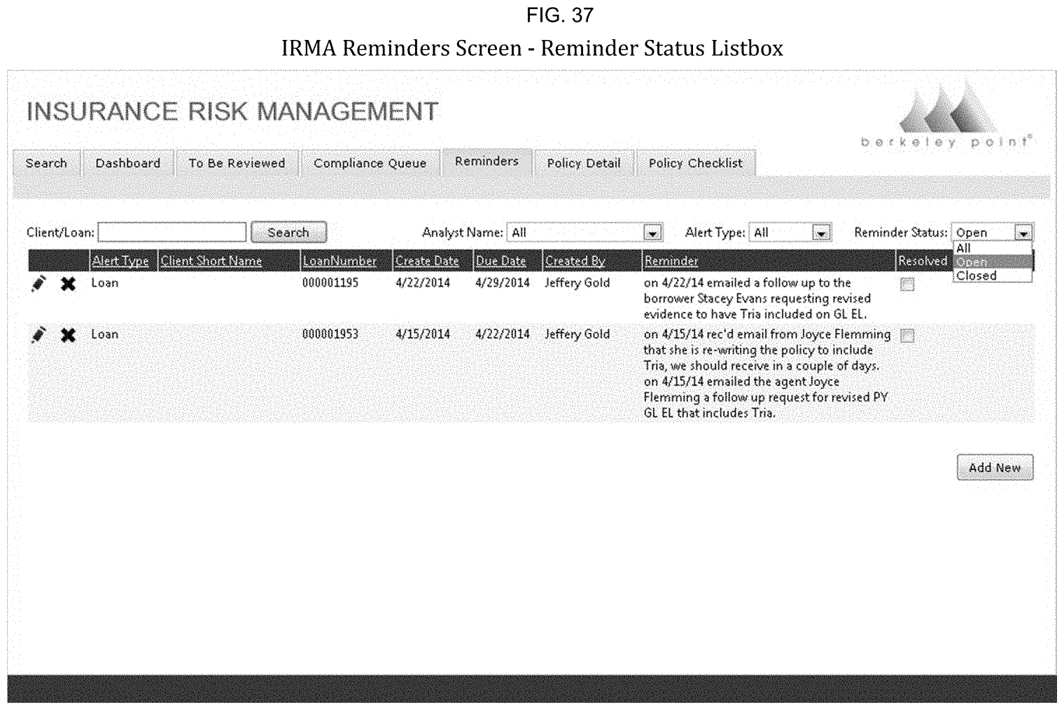

FIG. 37 depicts an exemplary reminder status selection box of an exemplary reminders tab according to an embodiment.

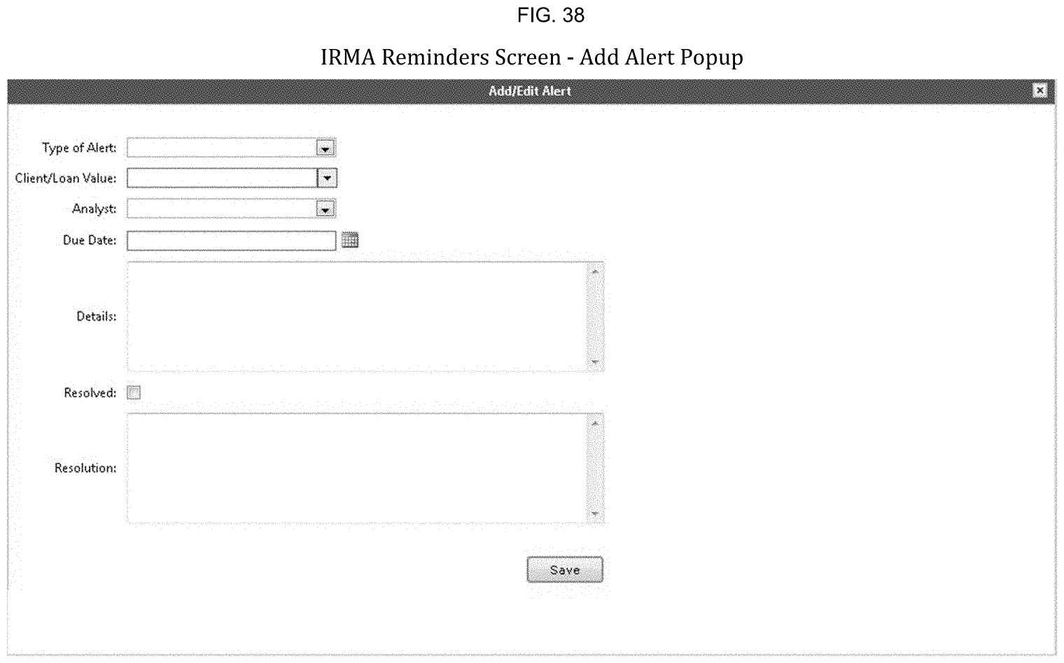

FIG. 38 depicts an exemplary “add alert” popup according to an embodiment. The add alert popup may be accessible from the reminders screen, e.g., by selecting an alert indicia or other indicia to trigger the popup. In some embodiments, the popup may be triggered automatically based on one or more criteria being satisfied (e.g., conditions that automatically trigger an alert). In some embodiments, alert information such as type of alert, client/loan value, analyst, due date, details, whether or not the alert has been resolved, and information about its resolution may be input and saved via this interface.

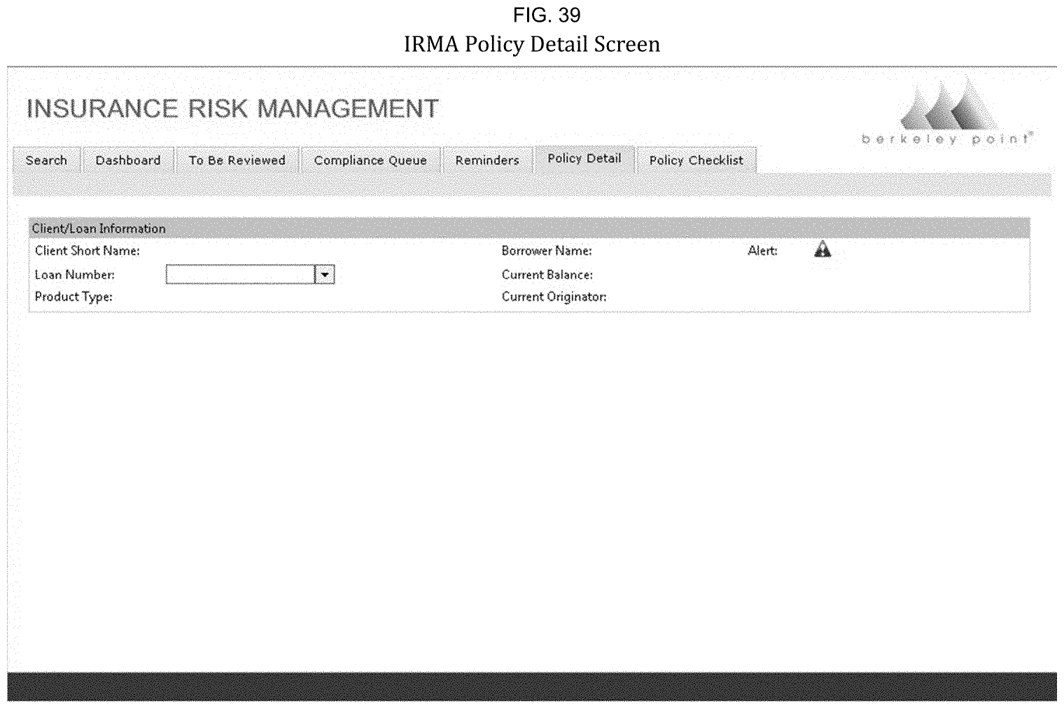

FIGS. 39-44 depict exemplary user interfaces and functionalities of a policy detail tab according to an embodiment.

FIG. 39 depicts an exemplary user interface of a policy detail tab according to an embodiment.

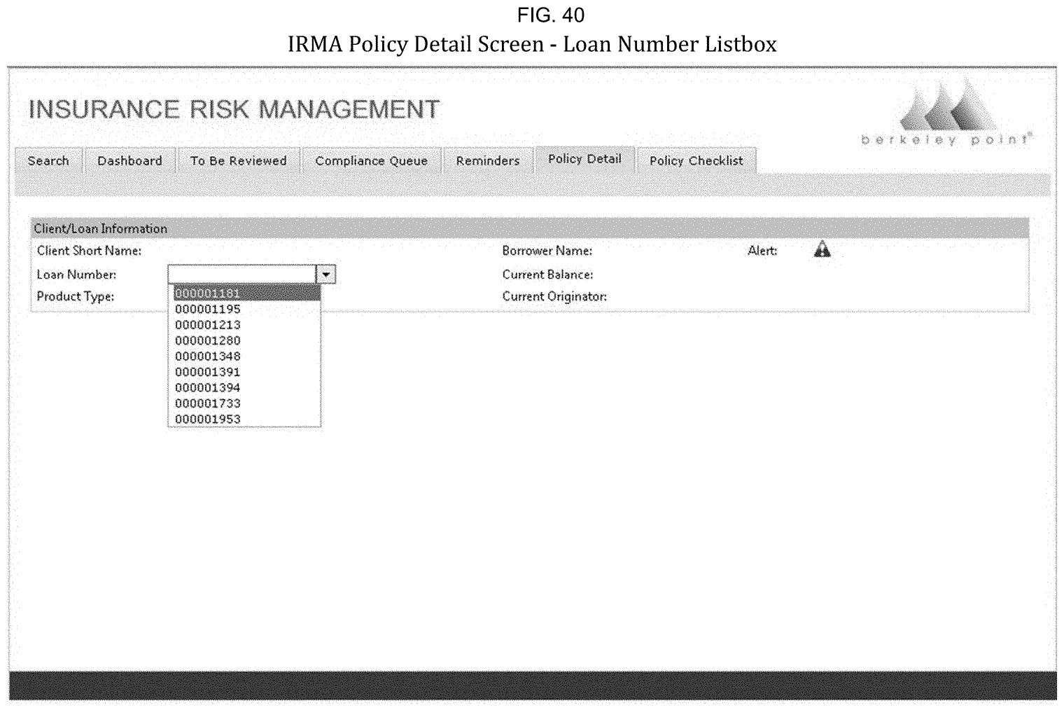

FIG. 40 depicts an exemplary loan number selection box of a policy detail tab according to an embodiment.

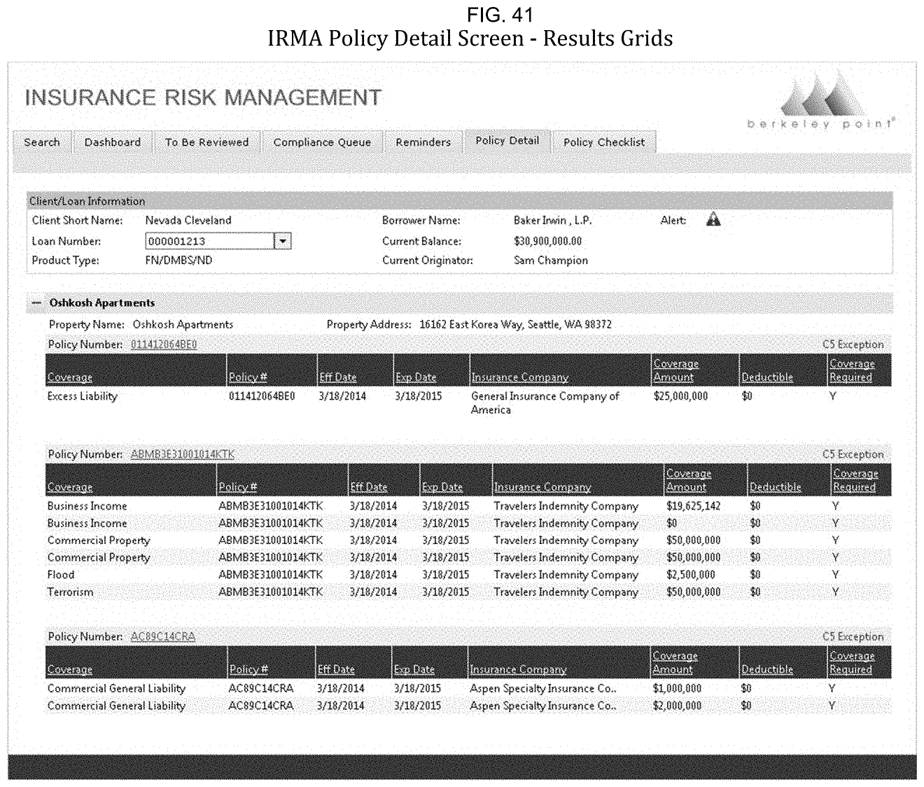

FIG. 41 depicts an exemplary results grid of a policy detail tab for a given loan number according to an embodiment.

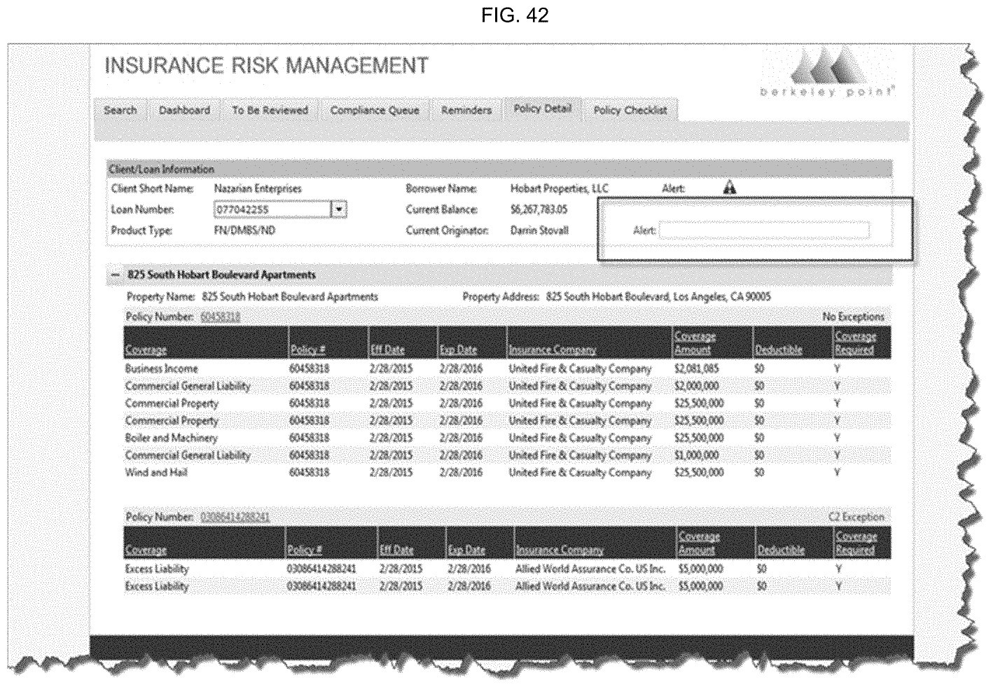

FIG. 42 depicts an exemplary results grid and an alert input box for a policy detail tab according to an embodiment.

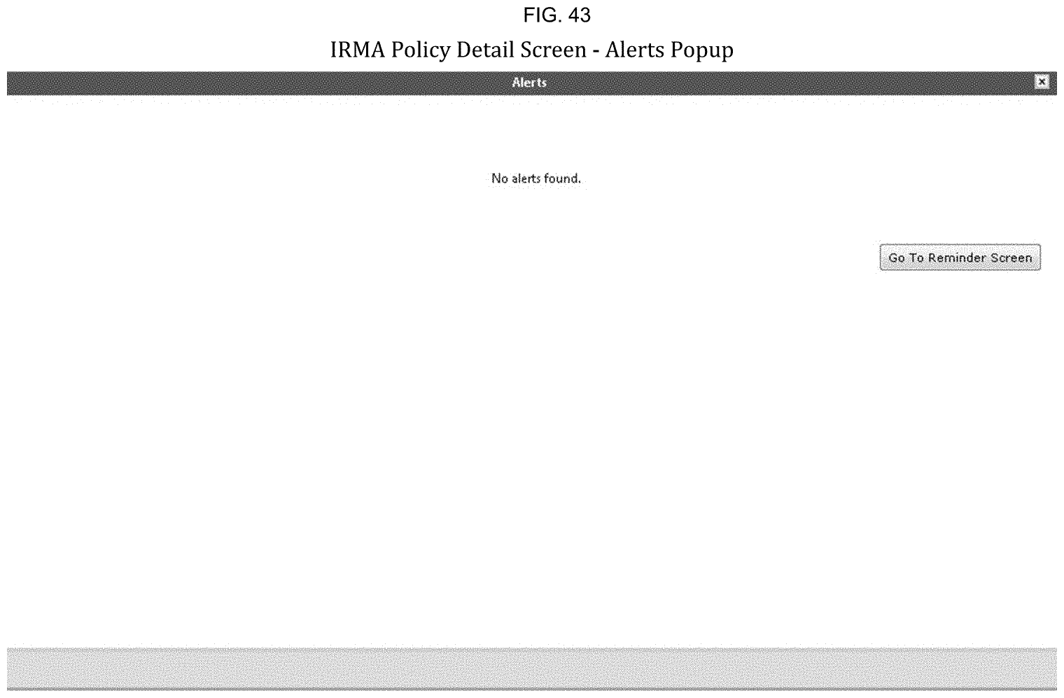

FIG. 43 depicts an exemplary alerts pop-up window interface accessible from or generated from a policy detail tab according to an embodiment.

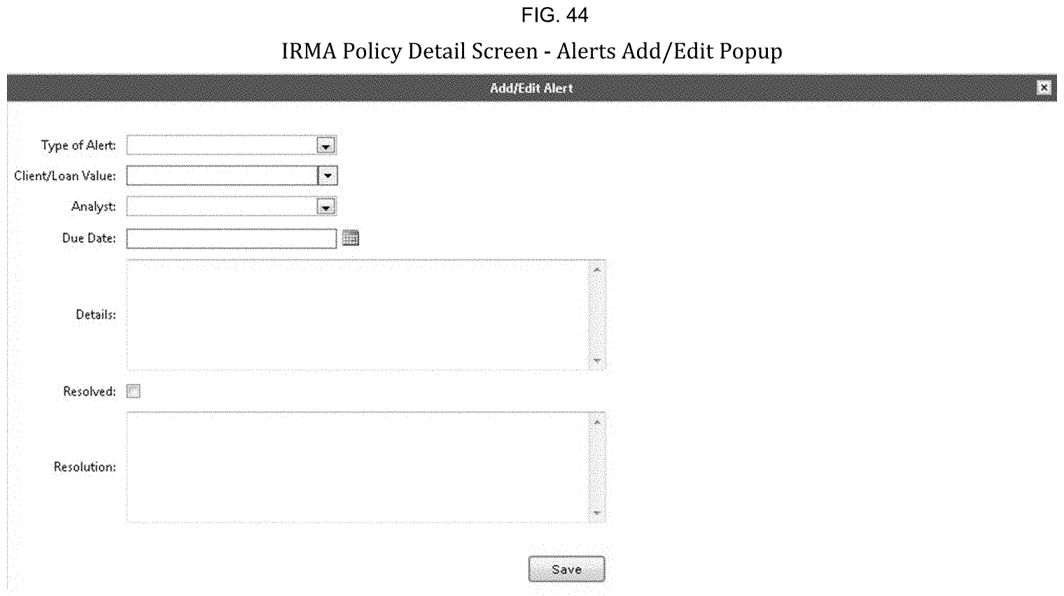

FIG. 44 depicts an exemplary alerts add/edit pop-up window interface accessible from or generated from a policy detail tab according to an embodiment. In some embodiments, a Policy Detail tab may display information such as insurance coverage detail, e.g., that mirrors information entered into the Servicing System.

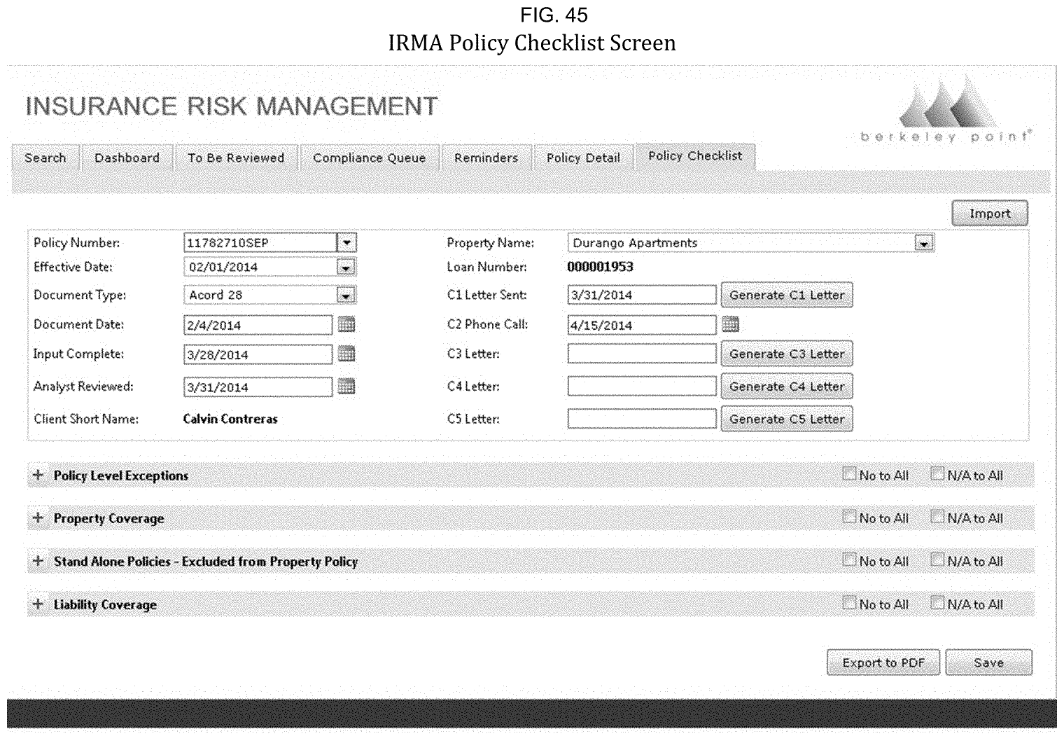

FIGS. 45-54 depict exemplary user interfaces and functionalities of, or accessible via, a policy checklist tab according to an embodiment. In some embodiments, a Policy Checklist tab may display information such as a comprehensive list of policy and coverage level data points to be reviewed for compliance against applicable insurance requirements. In some embodiments, a policy checklist may be manually (or automatically) completed in the IRMA system. In some embodiments, noted exceptions (noted by a user or system) may feed to a compliance queue for monitoring resolution.

FIG. 45 depicts an exemplary user interface of a policy checklist tab according to an embodiment.

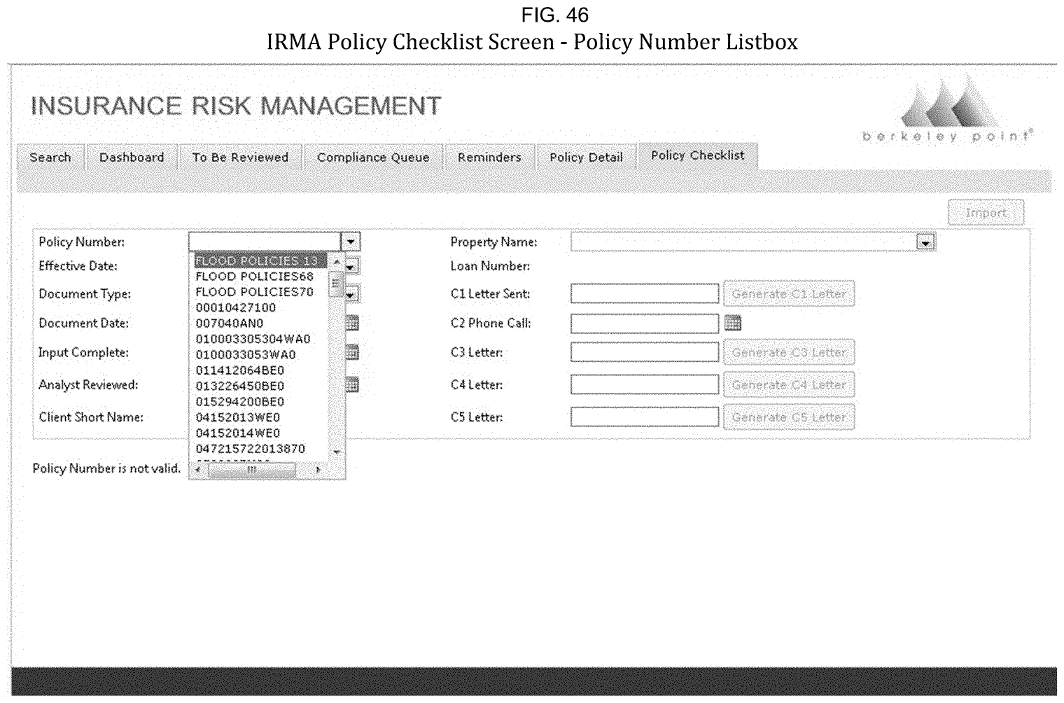

FIG. 46 depicts an exemplary policy number selection box of a policy checklist tab according to an embodiment.

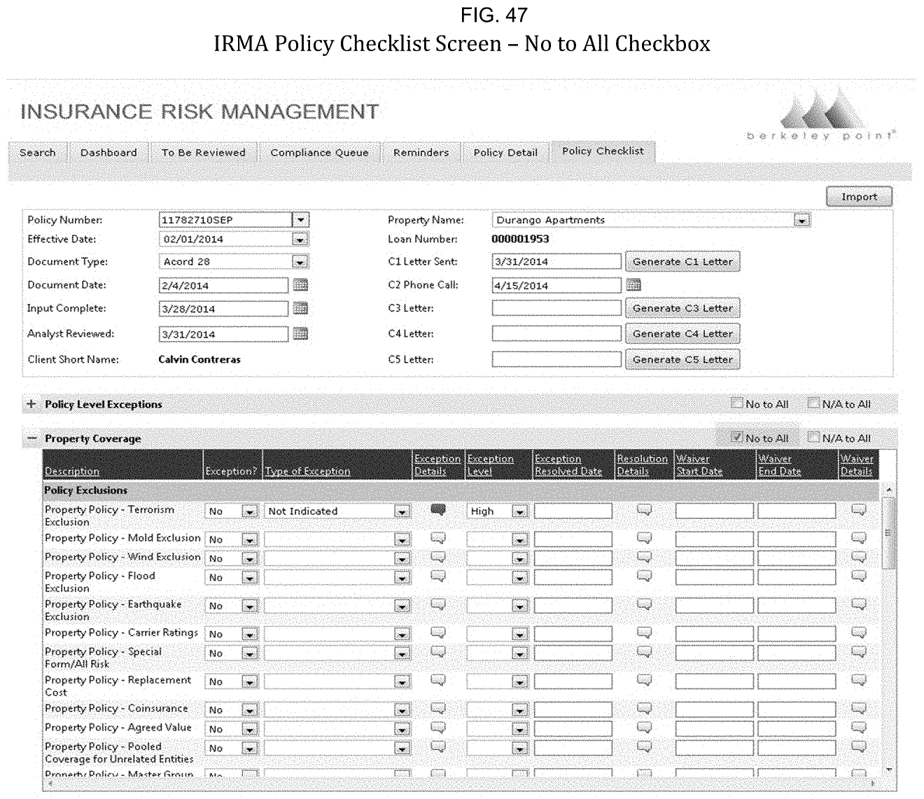

FIG. 47 depicts an exemplary policy checklist tab having a selectable “no to all” indicia according to an embodiment.

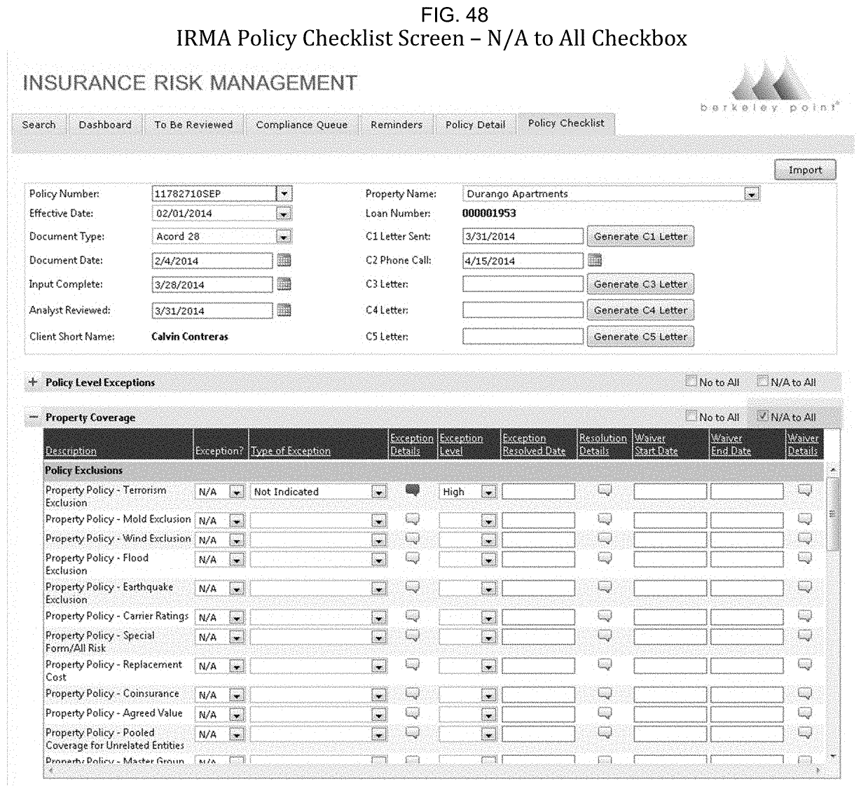

FIG. 48 depicts an exemplary policy checklist tab having a selectable “N/A to all” indicia according to an embodiment.

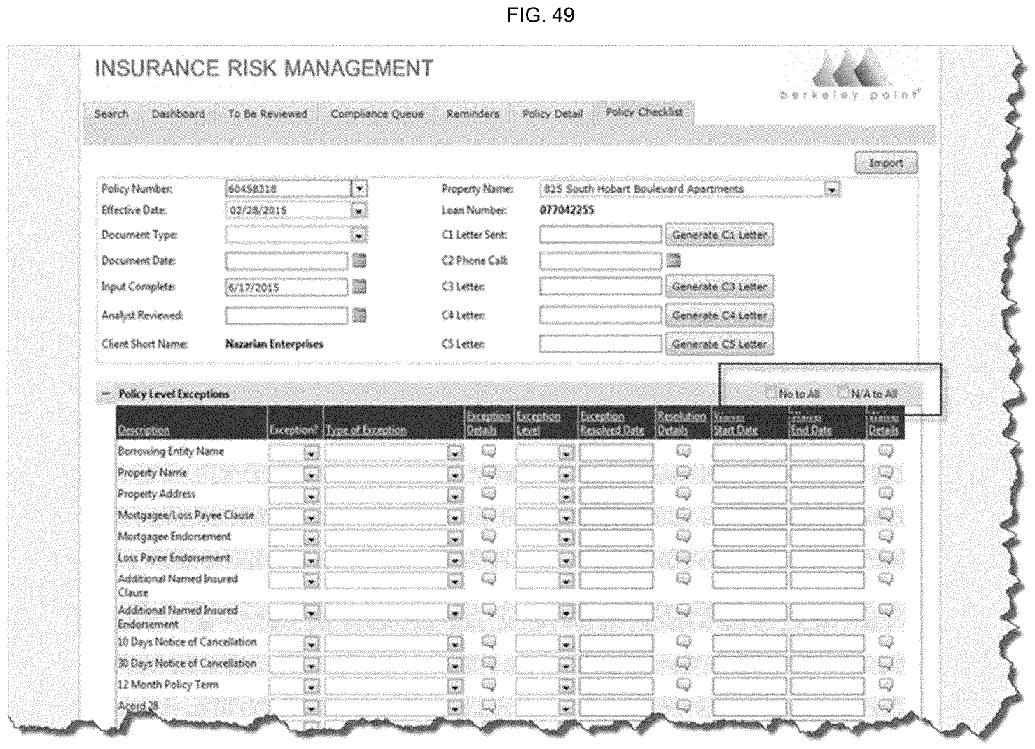

FIG. 49 depicts an exemplary policy checklist tab having selectable “no to all” and “N/A to all” indicia for policy level exceptions according to an embodiment.

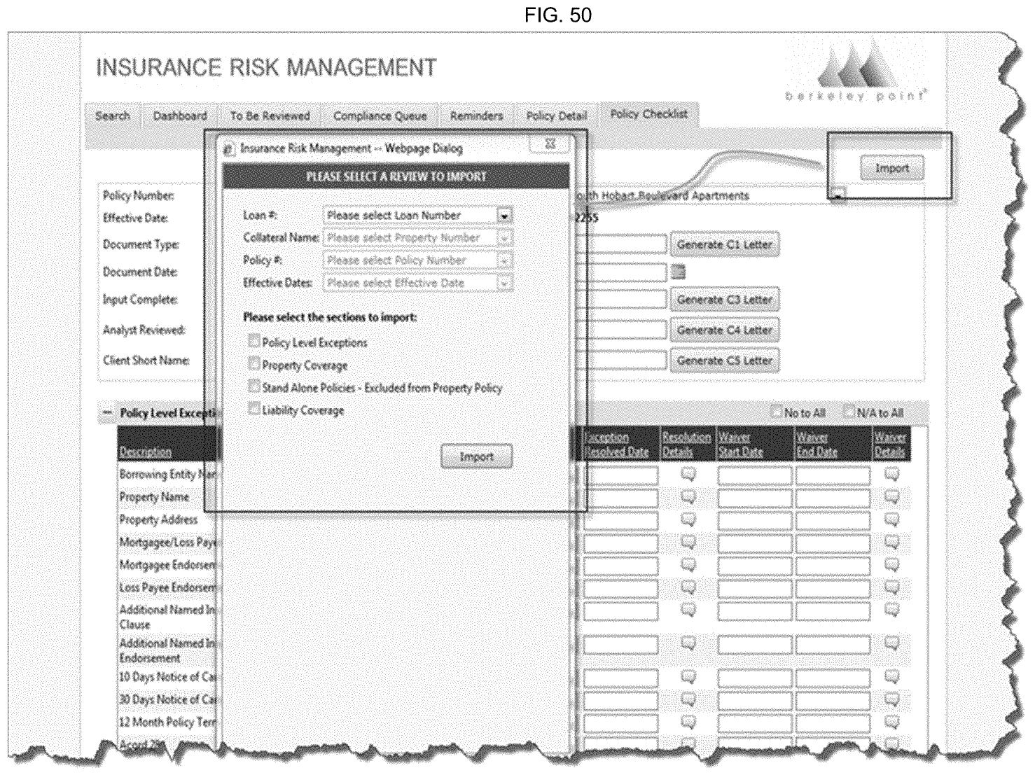

FIG. 50 depicts an exemplary import dialog pop-up accessible from or generated from a policy checklist tab according to an embodiment. For example, a checklist from another policy may be imported for use with other data such as another policy.

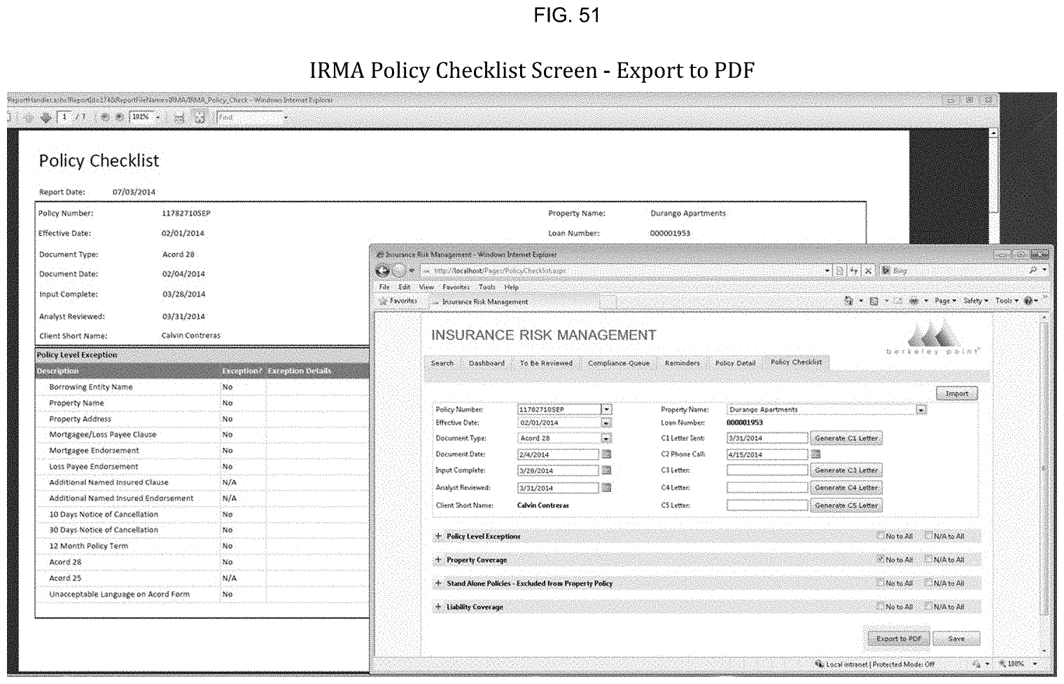

FIG. 51 depicts an exemplary export (e.g., to pdf) pop-up accessible from or generated from a policy checklist tab according to an embodiment. In some embodiments, a Policy Checklist can be exported to PDF (or other file format) for storing with a loan file.

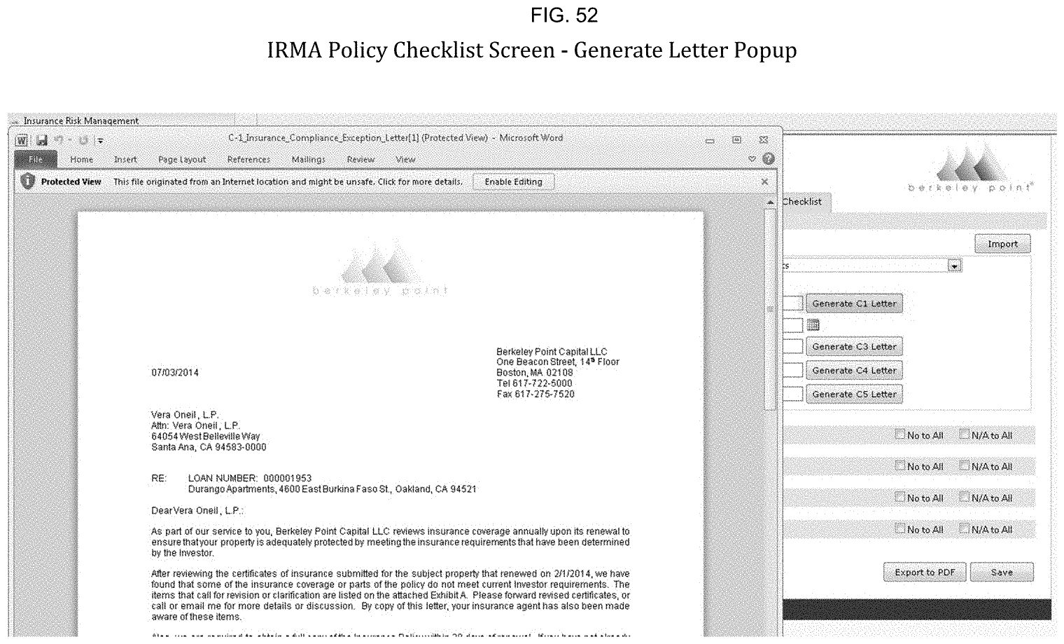

FIG. 52 depicts an exemplary generate letter popup window according to an embodiment. In some embodiments, a Letters function may enable users and/or server to generate or auto-generate one or more letters to be sent to a party such as a borrower. Letters may be generated based on information specific to the borrower, user, loan, etc. Different letter types may be used based on different stages in the compliance process. Letters may be generated in Word (or other) format and may contain a mix of canned text and insurance exception data generated from IRMA.

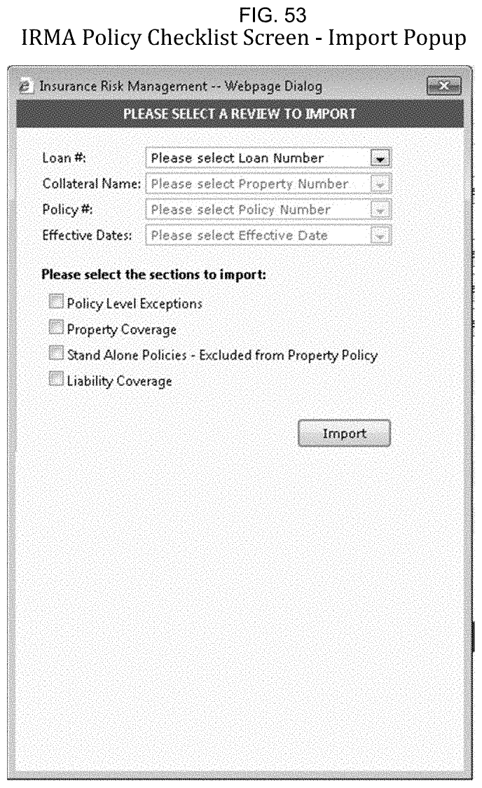

FIG. 53 depicts an exemplary import popup according to an embodiment.

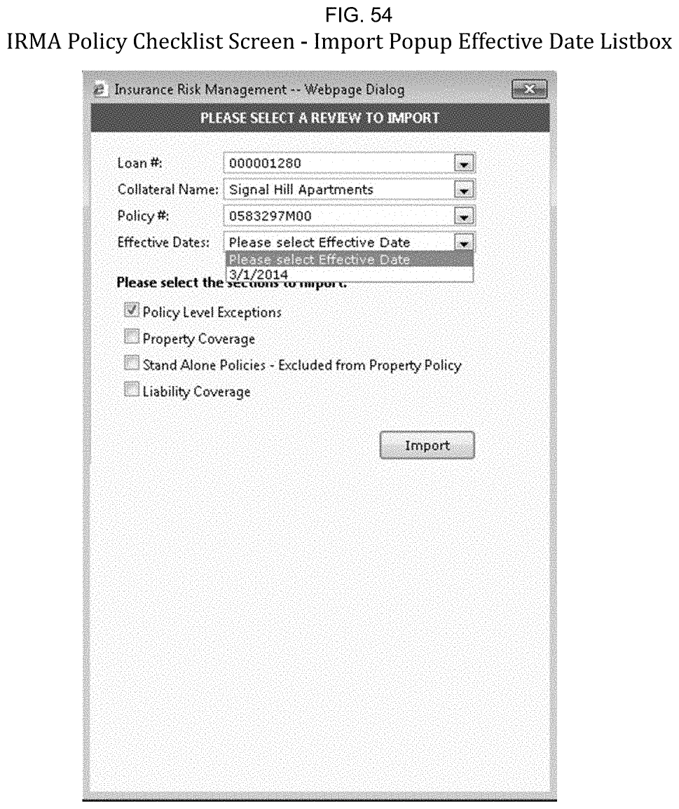

FIG. 54 depicts an exemplary effective date listbox in an exemplary import popup according to an embodiment.

In some embodiments, a Reports function may enable the creation of one or more reports containing data from IRMA. In some embodiments, the reports may be generated via an internal reporting system at the server, e.g., using one or more local databases. In some embodiments, reports may be generated based at least in part on one or more databases of a data provider and/or user.

In some embodiments, loan status information can be pulled from Enterprise into IRMA.

In some embodiments, Add Property Name is available in the reminder screen.

In some embodiments, an alert icon (e.g., on policy detail screen) may change color when an alert exists.

In some embodiments, there may be a direct link from Alert to editing field.

In some embodiments, loans may be displayed by Client Short Name.

In some embodiments, the system may provide separate review sections on the policy checklist for stand-alone policies.

In some embodiments, the formatting style for deficiencies may translate between IRMA and deficiency letters.

In some embodiments, blanket policy reviews may be linked.

In some embodiments, the system may automatically generate waiver expiration notifications to borrowers and other users (e.g., via letter, email, or other communication).

In some embodiments, waivers on blanket policies may be visible on all applicable loans.

Some embodiments may provide an incorporate blanket policy review form.

In some embodiments, an Alert section may be provided in the policy detail tab. In some embodiments, alerts may be input manually, e.g., by clicking an “alert” icon that triggers an “alert form,” and then filling in the form, e.g., manually. The alert may be tied to one or more data fields or items such as a specific loan or loan number, borrower, or other data. When information about the item (such as the specific loan number) is displayed, an alert icon indicating the alert may also be displayed. A user may then select the alert to display all the information in the alert. In some embodiments, all or part of the alert may be displayed instead of (or in addition to) an alert icon.

In some embodiments, in the policy checklist tab—we are able to check off “no to All or N/A to all.”

In some embodiments, in the policy checklist tab—we are able to “import” a checklist from another policy — useful for blanket policies.

In some embodiments, in the search screen we are able to check “Active only” so that we only show loans that have a currently have a policy in force.

In some embodiments, in the search screen we are able to check “Remove” so that we can see loans that we have removed from the policy detail screen.

In some embodiments, in the search screen, users may check off “Remove” so that a policy will no longer be shown in certain areas (e.g., so that it will no longer be listed in policy detail screen).

In some embodiments, a compliance item may be in only one queue (or many queues) at a time on the Dashboard. Such compliance item may move from C2/C2 Due to C3/C3 Due. In some embodiments, C1, C2, C3, etc., may refer to different times (e.g., C2 may be associated with a phone call that should be made to a borrower in July, and C3 may be associated with a letter that should be sent to the borrower and/or title holder in August).

In some embodiments, the compliance queue on dashboard may count exception items (e.g., it may automatically count 14 exception items, e.g., for a particular borrower, property, loan, insurance policy, portfolio, or other criteria.

One or more additional embodiments and features are described in U.S. Provisional Application Ser. No. 62/014,493, which is incorporated by reference herein.

Exemplary embodiments: It should be appreciated that each of the claims listed below in this application filed Jun. 19, 2015, are also exemplary embodiments, and are incorporated herein by reference as exemplary embodiments (in addition to them being claims).

### XII. Alternative Technologies

It will be understood that the technologies described herein for making, using, or practicing various embodiments are but a subset of the possible technologies that may be used for the same or similar purposes. The particular technologies described herein are not to be construed as limiting. Rather, various embodiments contemplate alternate technologies for making, using, or practicing various embodiments.

While this disclosure has been described in terms of certain embodiments and generally associated methods, alterations and permutations of the various systems, methods, software, and other embodiments will be apparent to those skilled in the art. Accordingly, the above description of example embodiments does not constrain this disclosure. Other changes, substitutions, and alterations are also possible without departing from the spirit and scope of this disclosure, e.g., as defined by the claims herein.

In particular, it should be appreciated that while this disclosure has generally been described in reference to loans and insurance policies, the features and embodiments described herein may also apply to other financial instruments, other types of risk, and other fields.

The following sections I-XI provide a guide to interpreting the present application.

### I. Terms

The term “product” means any machine, manufacture and/or composition of matter, unless expressly specified otherwise.

The term “process” means a process, algorithm, method or the like, unless expressly specified otherwise.

Each process (whether called a method, algorithm or otherwise) inherently includes one or more steps, and therefore all references to a “step” or “steps” of a process have an inherent antecedent basis in the mere description of a process, or in the mere recitation of the term ‘process’ or a like term. Accordingly, any reference in a claim to a ‘step’ or ‘steps’ of a process has sufficient antecedent basis.

The term “invention” and the like mean “the one or more inventions disclosed in this application”, unless expressly specified otherwise.

The terms “an embodiment”, “embodiment”, “embodiments”, “the embodiment”, “the embodiments”, “one or more embodiments”, “some embodiments”, “certain embodiments”, “one embodiment”, “another embodiment” and the like mean “one or more (but not all) embodiments of the invention”, unless expressly specified otherwise.

The term “variation” of an invention means an embodiment of the invention, unless expressly specified otherwise.

The term “indication” is used in an extremely broad sense. An “indication” of a thing should be understood to include anything that may be used to determine the thing.

An indication of a thing may include an electronic message that identifies the thing (e.g., an identification of a widget by a serial number affixed to the widget, an identification of a widget by one or more characteristics of the widget). An indication of a thing may include information that may be used to compute and/or look-up a thing (e.g., information identifying a machine of which a widget is a part that may be used to determine the widget). An indication of a thing may specify things that are related to the thing (e.g., characteristics of the thing, a name of the thing, a name of a thing related to the thing). An indication of a thing may not specify things that are related to the thing (e.g., a letter “a” may be an indication of a widget of a computer system that is configured to interpret the letter “a” to identify the widget). An indication of a thing may include a sign, a symptom, and/or a token of the thing. An indication, for example, may include a code, a reference, an example, a link, a signal, and/or an identifier. An indication of a thing may include information that represents, describes, and/or otherwise is associated with the thing.

A transformation of an indication of a thing may be an indication of the thing (e.g., an encrypted indication of a thing may be an indication of the thing). An indication of a thing may include the thing itself, a copy of the thing, and/or a portion of the thing. An indication of a thing may be meaningless to a thing that is not configured to understand the indication (e.g., a person may not understand that a letter “a” indicates a widget, but it may nonetheless be an indication of the widget because the computer system may determine the widget from the letter “a”). It should be understood that the fact that an indication of a thing may be used to determine the thing does not mean that the thing or anything else is determined. An indication of a thing may include an indication of any number of the thing unless specified otherwise. An indication of a thing may include an indication of other things (e.g., an electronic message that indicates may things). (Indication can be used as a very broad term in claim language. For example: receiving an indication of a financial instrument.)

The term “represent” means (1) to serve to express, designate, stand for, or denote, as a word, symbol, or the like does; (2) to express or designate by some term, character, symbol, or the like; (3) to portray or depict or present the likeness of, as a picture does; or (4) to serve as a sign or symbol of.

A reference to “another embodiment” in describing an embodiment does not imply that the referenced embodiment is mutually exclusive with another embodiment (e.g., an embodiment described before the referenced embodiment), unless expressly specified otherwise. Similarly, the mere fact that two (or more) embodiments are referenced does not imply that those embodiments are mutually exclusive.

One embodiment of the invention may include or cover or embrace more than one other embodiment of the invention. For example, a first embodiment comprising elements a, b, and c may cover a second embodiment that comprises elements a, b, c, and d as well as a third embodiment covering elements a, b, c, and e. Similarly, each of the first, second, and third embodiments may cover a fourth embodiment comprising elements a, b, c, d, and e.

The terms “including”, “comprising” and variations thereof mean “including but not necessarily limited to”, unless expressly specified otherwise. Thus, for example, the sentence “the machine includes a red widget and a blue widget” means the machine includes the red widget and the blue widget but may possibly include one or more other items as well.

The term “consisting of” and variations thereof mean “including and also limited to”, unless expressly specified otherwise. Thus, for example, the sentence “the machine consists of a red widget and a blue widget” means the machine includes the red widget and the blue widget but does not include anything else.

The term “compose” and variations thereof mean “to make up the constituent parts of, component of, or member of”, unless expressly specified otherwise. Thus, for example, the sentence “the red widget and the blue widget compose a machine” means the machine includes the red widget and the blue widget.

The term “exclusively compose” and variations thereof mean “to make up exclusively the constituent parts of, to be the only components of, or to be the only members of”, unless expressly specified otherwise. Thus, for example, the sentence “the red widget and the blue widget exclusively compose a machine” means the machine consists of the red widget and the blue widget (i.e. and nothing else).

The terms “a”, “an” and “the” refer to “one or more”, unless expressly specified otherwise. Thus, for example, the phrase “a widget” means one or more widgets, unless expressly specified otherwise. Similarly, after reciting the phrase “a widget”, a subsequent recitation of the phrase “the widget” means “the one or more widgets”. Accordingly, it should be understood that the word “the” may also refer to a specific term having antecedent basis. For example, if a paragraph mentions “a specific single feature” and then refers to “the feature,” then the phrase “the feature” should be understood to refer to the previously mentioned “a specific single feature.” (It should be understood that the term “a” in “a specific single feature” refers to “one” specific single feature and not “one or more” specific single features.)

The term “plurality” means “two or more”, unless expressly specified otherwise.

The term “herein” means “in the present application, including anything which may be incorporated by reference”, unless expressly specified otherwise.

The phrase “at least one of”, when such phrase modifies a plurality of things (such as an enumerated list of things), means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel. The phrase “at least one of”, when such phrase modifies a plurality of things does not mean “one of each of” the plurality of things. For example, the phrase “at least one of a widget, a car and a wheel” does not mean “one widget, one car and one wheel”.

Numerical terms such as “one”, “two”, etc. when used as cardinal numbers to indicate quantity of something (e.g., one widget, two widgets), mean the quantity indicated by that numerical term, but do not mean at least the quantity indicated by that numerical term. For example, the phrase “one widget” does not mean “at least one widget”, and therefore the phrase “one widget” does not cover, e.g., two widgets.

The phrase “based on” does not mean “based only on”, unless expressly specified otherwise. In other words, the phrase “based on” covers both “based only on” and “based at least on”. The phrase “based at least on” is equivalent to the phrase “based at least in part on”. For example, the phrase “element A is calculated based on element B and element C” covers embodiments where element A is calculated as the product of B times C (in other words, A=B×C), embodiments where A is calculated as the sum of B plus C (in other words, A=B+C), embodiments where A is calculated as a product of B times C times D, embodiments where A is calculated as a sum of the square root of B plus C plus D times E, and so on.

The term “represent” and like terms are not exclusive, unless expressly specified otherwise. For example, the term “represents” does not mean “represents only”, unless expressly specified otherwise. For example, the phrase “the data represents a credit card number” covers both “the data represents only a credit card number” and “the data represents a credit card number, and the data also represents something else”.

The term “whereby” is used herein only to precede a clause or other set of words that express only the intended result, objective or consequence of something that is explicitly recited before the term “whereby”. Thus, when the term “whereby” is used in a claim, the clause or other words that the term “whereby” modifies do not establish specific further limitations of the claim or otherwise restrict the meaning or scope of the claim.

The terms “e.g.”, “such as” and like terms mean “for example”, and thus do not limit the term or phrase they explain. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “respective” and like terms mean “taken individually”. Thus if two or more things have “respective” characteristics, then each such thing has its own characteristic, and these characteristics can be different from each other but need not be. For example, the phrase “each of two machines has a respective function” means that the first of the two machines has a function and the second of the two machines has a function as well. The function of the first machine may or may not be the same as the function of the second machine.

The term “i.e.” and like terms mean “that is”, and thus limits the term or phrase it explains. For example, in the sentence “the computer sends data (i.e., instructions) over the Internet”, the term “i.e.” explains that “instructions” are the “data” that the computer sends over the Internet.

A numerical range includes integers and non-integers in the range, unless expressly specified otherwise. For example, the range “1 to 10” includes the integers from 1 to 10 (e.g., 1, 2, 3, 4, . . . 9, 10) and non-integers (e.g., 1.0031415926, 1.1, 1.2, . . . 1.9).

Where two or more terms or phrases are synonymous (e.g., because of an explicit statement that the terms or phrases are synonymous), instances of one such term or phrase does not mean instances of another such term or phrase must have a different meaning. For example, where a statement renders the meaning of “including” to be synonymous with “including but not limited to”, the mere usage of the phrase “including but not limited to” does not mean that the term “including” means something other than “including but not limited to”.

### II. Determining

The term “determining” and grammatical variants thereof (e.g., to determine a price, determining a value, the determination of an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), rendering into electronic format or digital representation, ascertaining and the like. Also, “determining” can include receiving (e.g., receiving information), accessing (e.g., accessing data in a memory) and the like. Also, “determining” can include resolving, selecting, choosing, establishing, and the like.

The term “determining” does not imply certainty or absolute precision, and therefore “determining” can include estimating, extrapolating, predicting, guessing, averaging and the like.

The term “determining” does not imply that mathematical processing must be performed and does not imply that numerical methods must be used and does not imply that an algorithm is used.

The term “determining” does not imply that any particular device must be used. For example, a computer need not necessarily perform the determining.

The term “determining” may include “calculating”. The term “calculating” should be understood to include performing one or more calculations. Calculating may include computing, processing, and/or deriving. Calculating may be performed by a computing device. For example, calculating a thing may include applying an algorithm to data by a computer processor and generating the thing as an output of the processor.

The term “determining” may include “referencing”. The term “referencing” should be understood to include making one or more reference, e.g., to a thing. Referencing may include querying, accessing, selecting, choosing, reading, and/or looking up. The act of referencing may be performed by a computing device. For example, referencing a thing may include reading a memory location in which the thing is stored by a processor.

The term “determining” may include “receiving”. For example, receiving a thing may include taking in the thing. In some embodiments, receiving may include acts performed to take in a thing, such as operating a network interface through which the thing is taken in. In some embodiments, receiving may be performed without acts performed to take in the thing, such as in a direct memory write or a hard-wired circuit. Receiving a thing may include receiving a thing from a remote source that may have calculated the thing.

### III. Forms of Sentences

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to that limitation (e.g., “the widget”), this mere usage does not imply that the first claim covers only one of the feature, and this does not imply that the second claim covers only one of the feature (e.g., “the widget” can cover both one widget and more than one widget).

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term, but that ordinal number does not have any other meaning or limiting effect — it is merely a convenient name. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. The mere usage of ordinal numbers does not define a numerical limit to the features identified with the ordinal numbers. For example, the mere usage of the ordinal numbers “first” and “second” before the term “widget” does not indicate that there are exactly two widgets.

When a single device, article or other product is described herein, in another embodiment more than one device or article (whether or not they cooperate) may alternatively be used in place of the single device or article that is described. Accordingly, the functionality that is described as being possessed by a device may alternatively be possessed by more than one device or article (whether or not they cooperate) in another embodiment.

Similarly, where more than one device, article or other product is described herein (whether or not they cooperate), in another embodiment a single device or article may alternatively be used in place of the more than one device or article that is described. For example, a plurality of computer-based devices may be substituted with a single computer-based device. In some embodiments, such a plurality of computer-based devices may operate together to perform one step of a process such as is common in grid computing systems. In some embodiments, such a plurality of computer-based devices may operate provide added functionality to one another so that the plurality may operate to perform one step of a process such as is common in cloud computing systems. (Conversely, a single computer-based device may be substituted with multiple computer-based devices operating in cooperation with one another. For example, a single computing device may be substituted with a server and a workstation in communication with one another over the internet.) Accordingly, the various functionality that is described as being possessed by more than one device or article may alternatively be possessed by a single device or article.

The functionality and/or the features of a single device that is described may, in another embodiment, be alternatively embodied by one or more other devices which are described but are not explicitly described as having such functionality or features. Thus, other embodiments need not include the described device itself, but rather can include the one or more other devices which would, in those other embodiments, have such functionality or features.

### IV. Disclosed Examples and Terminology Are Not Limiting

Neither the Title (set forth at the beginning of the first page of the present application) nor the Abstract (set forth at the end of the present application) is to be taken as limiting in any way the scope of the disclosed invention, is to be used in interpreting the meaning of any claim or is to be used in limiting the scope of any claim. An Abstract has been included in this application merely because an Abstract is required under 37 C.F.R. § 1.72(b).

The headings of sections provided in the present application are for convenience only and are not to be taken as limiting the disclosure in any way.

Numerous embodiments are described in the present application and are presented for illustrative purposes only. The described embodiments are not, and are not intended to be, limiting in any sense. The disclosed invention is widely applicable to numerous embodiments, as is readily apparent from the disclosure. One of ordinary skill in the art will recognize that the disclosed invention may be practiced with various modifications and alterations, such as structural, logical, software, and electrical modifications. Although particular features of the disclosed invention may be described with reference to one or more particular embodiments and/or drawings, it should be understood that such features are not limited to usage in the one or more particular embodiments or drawings with reference to which they are described, unless expressly specified otherwise.

Though an embodiment may be disclosed as including several features, other embodiments of the invention may include fewer than all such features. Thus, for example, a claim may be directed to less than the entire set of features in a disclosed embodiment, and such claim would not be interpreted as requiring features beyond those features that the claim expressly recites.

No embodiment of method steps or product elements described in the present application constitutes the invention claimed herein, or is essential to the invention claimed herein, or is coextensive with the invention claimed herein, except where it is either expressly stated to be so in this specification or (with respect to a claim and the invention defined by that claim) expressly recited in that claim.

Any preambles of the claims that recite anything other than a statutory class shall be interpreted to recite purposes, benefits and possible uses of the claimed invention, and such preambles shall not be construed to limit the claimed invention.

The present disclosure is not a literal description of all embodiments of the invention. Also, the present disclosure is not a listing of features of the invention which must be present in all embodiments.

All disclosed embodiments are not necessarily covered by the claims (even including all pending, amended, issued and canceled claims). In addition, a disclosed embodiment may be (but need not necessarily be) covered by several claims. Accordingly, where a claim (regardless of whether pending, amended, issued or canceled) is directed to a particular embodiment, such is not evidence that the scope of other claims do not also cover that embodiment.

Devices that are described as in communication with each other need not be in continuous communication with each other, unless expressly specified otherwise. On the contrary, such devices need only transmit to each other as necessary or desirable and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries. Devices are in communication with one another if they are capable of at least one-way communication with one another. For example, a first device is in communication with a second device if the first device is capable of transmitting information to the second device. Similarly, the second device is in communication with the first device if the second device is capable of receiving information from the first device.

A description of an embodiment with several components or features does not imply that all or even any of such components or features are required. On the contrary, a variety of optional components are described to illustrate the wide variety of possible embodiments of the present invention. Unless otherwise specified explicitly, no component or feature is essential or required.

Although process steps, algorithms or the like may be described or claimed in a particular sequential order, such processes may be configured to work in different orders. In other words, any sequence or order of steps that may be explicitly described or claimed does not necessarily indicate a requirement that the steps be performed in that order. The steps of processes described herein may be performed in any order possible. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are preferred, essential or required. Various other embodiments within the scope of the described invention include other processes that omit some or all of the described steps. Unless otherwise specified explicitly, no step is essential or required.

Although a process may be described singly or without reference to other products or methods, in an embodiment the process may interact with other products or methods. For example, such interaction may include linking one business model to another business model. Such interaction may be provided to enhance the flexibility or desirability of the process.

Although a product may be described as including a plurality of components, aspects, qualities, characteristics and/or features, that does not indicate that any or all of the plurality are preferred, essential or required. Various other embodiments within the scope of the described invention include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, and a PDA” does not imply that any or all of the three items of that list are mutually exclusive and does not imply that any or all of the three items of that list are comprehensive of any category.

An enumerated list of items (which may or may not be numbered) does not imply that any or all of the items are equivalent to each other or readily substituted for each other.

All embodiments are illustrative, and do not imply that the invention or any embodiments were made or performed, as the case may be.

### V. Computing

It will be readily apparent to one of ordinary skill in the art that the various processes described herein may be implemented by, e.g., appropriately programmed general purpose computers, special purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in, e.g., one or more computer programs, one or more scripts.

The term “compute” shall mean to determine using a processor in accordance with a software algorithm.

A “processor” means one or more microprocessors, central processing units (CPUs), computing devices, microcontrollers, digital signal processors, graphics processing units (GPUs) or like devices or any combination thereof, regardless of the architecture (e.g., chip-level multiprocessing or multi-core, RISC, CISC, Microprocessor without Interlocked Pipeline Stages, pipelining configuration, simultaneous multithreading, microprocessor with integrated graphics processing unit, GPGPU).

A “computing device” means one or more microprocessors, central processing units (CPUs), computing devices, microcontrollers, digital signal processors, graphics card, mobile gaming device, or like devices or any combination thereof, regardless of the architecture (e.g., chip-level multiprocessing or multi-core, RISC, CISC, Microprocessor without Interlocked Pipeline Stages, pipelining configuration, simultaneous multithreading).

Thus a description of a process is likewise a description of an apparatus for performing the process. The apparatus that performs the process can include, e.g., a processor and those input devices and output devices that are appropriate to perform the process. For example, a description of a process is a description of an apparatus comprising a processor and memory that stores a program comprising instructions that, when executed by the processor, direct the processor to perform the method.

The apparatus that performs the process can include a plurality of computing devices that work together to perform the process. Some of the computing devices may work together to perform each step of a process, may work on separate steps of a process, may provide underlying services that other computing devices that may facilitate the performance of the process. Such computing devices may act under instruction of a centralized authority. In another embodiment, such computing devices may act without instruction of a centralized authority. Some examples of apparatus that may operate in some or all of these ways may include grid computer systems, cloud computer systems, peer-to-peer computer systems, computer systems configured to provide software as a service, and so on. For example, the apparatus may comprise a computer system that executes the bulk of its processing load on a remote server, but outputs display information to and receives user input information from a local user computer, such as a computer system that executes VMware software.

Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium, a plurality of the same, or a combination of different media, that participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

The term “tangible computer-readable medium” refers to a “computer-readable medium” that comprises a hardware component, such as optical or magnetic disks.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), wireless local area network communication defined by the IEEE 802.11 specifications whether or not they are approved by the Wi-Fi Alliance, SAP, ATP, Bluetooth™, and TCP/IP, TDMA, CDMA, and 3G; and/or (iv) encrypted to ensure privacy or prevent fraud in any of a variety of ways well known in the art.

The term “database” refers to any electronically stored collection of data that is stored in a retrievable format.

The term “data structure” refers to a database in a hardware machine such as a computer.

The term “network” means a series of points or nodes interconnected by communication paths. For example, a network can include a plurality of computers or communication devices interconnected by one or more wired and/or wireless communication paths. Networks can interconnect with other networks and contain subnetworks.

The term “predetermined” means determined beforehand, e.g., before a present time or a present action. For example, the phrase “displaying a predetermined value” means displaying a value that was determined before the act of displaying.

The term “condition” means (1) a premise upon which the fulfillment of an agreement depends, or (2) something essential to the appearance or occurrence of something else.

The term “transaction” means (1) an Exchange or transfer of goods, services, or funds, or (2) a communicative action or activity involving two parties or things that reciprocally affect or influence each other.

Thus a description of a process is likewise a description of a computer-readable medium storing a program for performing the process. The computer-readable medium can store (in any appropriate format) those program elements which are appropriate to perform the method. For example, a description of a process is a description of a computer-readable storage medium that stores a program comprising instructions that, when executed by a processor, direct the processor to perform the method.

Just as the description of various steps in a process does not indicate that all the described steps are required, embodiments of an apparatus include a computer or computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) could be used to store and manipulate the data types described herein. Likewise, object methods or behaviors of a database can be used to implement various processes, such as the described herein. In addition, the databases may, in a known manner, be stored locally or remotely from a device which accesses data in such a database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel®, Pentium®, or Centrino™, Atom™ or Core™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

Where a process is described, in an embodiment the process may operate without any user intervention. In another embodiment, the process includes some human intervention (e.g., a step is performed by or with the assistance of a human).

As used herein, the term “encryption” refers to a process for obscuring or hiding information so that the information is not readily understandable without special knowledge. The process of encryption may transform raw information, called plaintext, into encrypted information. The encrypted information may be called ciphertext, and the algorithm for transforming the plaintext into ciphertext may be referred to as a cipher. A cipher may also be used for performing the reverse operation of converting the ciphertext back into plaintext. Examples of ciphers include substitution ciphers, transposition ciphers, and ciphers implemented using rotor machines.

In various encryption methods, ciphers may require a supplementary piece of information called a key. A key may consist, for example, of a string of bits. A key may be used in conjunction with a cipher to encrypt plaintext. A key may also be used in conjunction with a cipher to decrypt ciphertext. In a category of ciphers called symmetric key algorithms (e.g., private-key cryptography), the same key is used for both encryption and decryption. The sanctity of the encrypted information may thus depend on the key being kept secret. Examples of symmetric key algorithms are DES and AES. In a category of ciphers called asymmetric key algorithms (e.g., public-key cryptography), different keys are used for encryption and decryption. With an asymmetric key algorithm, any member of the public may use a first key (e.g., a public key) to encrypt plaintext into ciphertext. However, only the holder of a second key (e.g., the private key) will be able to decrypt the ciphertext back into plaintext. An example of an asymmetric key algorithm is the RSA algorithm.

### VI. Continuing Applications

The present disclosure provides, to one of ordinary skill in the art, an enabling description of several embodiments and/or inventions. Some of these embodiments and/or inventions may not be claimed in the present application but may nevertheless be claimed in one or more continuing applications that claim the benefit of priority of the present application.

Applicants intend to file additional applications to pursue patents for subject matter that has been disclosed and enabled but not claimed in the present application.

VII. 35 U.S.C. § 112, paragraph 6

In a claim, a limitation of the claim which includes the phrase “means for” or the phrase “step for” means that 35 U.S.C. § 112, paragraph 6, applies to that limitation.

In a claim, a limitation of the claim which does not include the phrase “means for” or the phrase “step for” means that 35 U.S.C. § 112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. § 112, paragraph 6, applies to that step(s).

With respect to a means or a step for performing a specified function in accordance with 35 U.S.C. § 112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in the present application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. § 112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

Where there is recited a means for performing a function that is a method, one structure for performing this method includes a computing device (e.g., a general purpose computer) that is programmed and/or configured with appropriate hardware to perform that function.

Also included is a computing device (e.g., a general purpose computer) that is programmed and/or configured with appropriate hardware to perform that function via other algorithms as would be understood by one of ordinary skill in the art.

### VIII. Disclaimer

Numerous references to a particular embodiment do not indicate a disclaimer or disavowal of additional, different embodiments, and similarly references to the description of embodiments which all include a particular feature do not indicate a disclaimer or disavowal of embodiments which do not include that particular feature. A clear disclaimer or disavowal in the present application will be prefaced by the phrase “does not include” or by the phrase “cannot perform”.

### IX. Incorporation By Reference

Any patent, patent application or other document referred to herein is incorporated by reference into this patent application as part of the present disclosure, but only for purposes of written description and enablement in accordance with 35 U.S.C. § 112, paragraph 1, and should in no way be used to limit, define, or otherwise construe any term of the present application, unless without such incorporation by reference, no ordinary meaning would have been ascertainable by a person of ordinary skill in the art. Such person of ordinary skill in the art need not have been in any way limited by any embodiments provided in the reference. Conversely, the definitions provided in this application should not be used to limit, define, or otherwise construe any term of any document incorporated herein by reference. The definitions set forth explicitly in this application are controlling notwithstanding the description of particular embodiments that may be incompatible with the definition(s).

Any incorporation by reference does not, in and of itself, imply any endorsement of, ratification of, or acquiescence in any statements, opinions, arguments or characterizations contained in any incorporated patent, patent application or other document, unless explicitly specified otherwise in this patent application.

### X. Prosecution History

In interpreting the present application (which includes the claims), one of ordinary skill in the art shall refer to the prosecution history of the present application, but not to the prosecution history of any other patent or patent application, regardless of whether there are other patent applications that are considered related to the present application, and regardless of whether there are other patent applications that share a claim of priority with the present application.

What is claimed is:

1. A method comprising:
for each of a plurality of properties that each comprise collateral for one or more loans each having insurance requirements, receiving, by at least one processor in electronic communication with at least one memory having at least one database, insurance information concerning each of one or more insurance policies associated with the respective property, in which the insurance information comprises compliance information indicative of whether one or more predetermined insurance requirements applicable to the respective one or more insurance policies associated with the respective property have been satisfied, the one or more predetermined insurance requirements comprising a first requirement applicable to a first insurance policy and a second requirement applicable to a second insurance policy;
based on the received compliance information, determining, by the at least one processor, for each of the one or more loans on each of the plurality of properties, whether each of the respective one or more predetermined insurance requirements have been satisfied, in which the act of determining whether each of the respective one or more predetermined insurance requirements have been satisfied comprises (1) determining that the first requirement associated with the first insurance policy has been satisfied and (2) determining that the second requirement associated with the second policy has not been satisfied;
populating, by the at least one processor, the at least one database based on the received insurance information, in which the act of populating the at least one database comprises (1) storing, in a first database entry associated with the first insurance policy, information indicating that the first requirement has been satisfied and (2) storing, in a second database entry associated with the second insurance policy, information indicating that the second requirement has not been satisfied;
receiving, by the at least one processor, from a first user a first request for information about whether the first requirement has been satisfied;
responsive to the first request, querying, by the at least one processor, the first database entry;
responsive to querying the first database entry, causing, by the at least one processor, first indicia indicating that the first requirement has been satisfied to be displayed at a user interface;
receiving, by the at least one processor, a second request for information about whether the second requirement has been satisfied;
responsive to the second request, querying, by the at least one processor, the second database entry;
responsive to querying the second database entry, causing, by the at least one processor, second indicia indicating that the second requirement has not been satisfied to be displayed at a user interface;
after causing the second indicia to be displayed, receiving, by the at least one processor, updated compliance information;
determining, by the at least one processor, that the second requirement has been satisfied based on the updated compliance information;
receiving, by the at least one processor, a third request for information about whether the second requirement has been satisfied; and
responsive to the third request, causing, by the at least one processor, third indicia indicating that the second requirement has been satisfied to be displayed at a user interface.
